(19) United States
(12) Patent Application Publication
(10) Pub. No.: US 2025/0358757 A1
(43) Pub. Date: Nov. 20, 2025

(54) TIMING ADVANCE GROUPS FOR MULTIPLE DOWNLINK CONTROL INFORMATION-BASED MULTIPLE TRANSMISSION AND RECEPTION POINTS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/866,335

(22) PCT Filed: Jul. 29, 2022
(86) PCT No.: PCT/CN2022/108830

§ 371 Date: Nov. 15, 2024

(51) Int. Cl. H04W 56/00; H04L 5/00

(52) U.S. Cl. CPC H04W 56/0045; H04L 5/0053

(57) ABSTRACT

Various aspects of the present disclosure generally relate to wireless communication. In some aspects, a user equipment (UE) may receive an indication of a first control resource set (CORESET) pool index and a second CORESET pool index associated with a serving cell of a network having a first physical cell identifier (PCI). The UE may receive an indication of a first timing advance group (TAG) identifier (ID) associated with the first CORESET pool index and a second TAG ID associated with the second CORESET pool index. The UE may receive, from the serving cell, an indication of one or more additional PCIs different from the first PCI. The UE may communicate with the network on the serving cell using a multi-TAG configuration or a single-TAG configuration based on PCIs associated with the first CORESET pool index and the second CORESET pool index. Numerous other aspects are described.

### FIELD OF THE DISCLOSURE

Aspects of the present disclosure generally relate to wireless communication and to techniques and apparatuses for timing advanced groups (TAGs) for multiple downlink control information (multi-DCI)-based multiple transmission and reception points (multi-TRP).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a first control resource set (CORESET) pool index value and a second CORESET pool index value associated with a serving cell of a network having a first physical cell identifier (PCI). The method may include receiving an indication of a first timing advance group (TAG) identifier (ID) and a second TAG ID associated with the serving cell, wherein the first TAG is associated with the first CORESET pool index value and the second TAG is associated with the second CORESET pool index value. The method may include receiving, from the serving cell, an indication of one or more additional PCIs different from the first PCI. The method may include communicating with the network on the serving cell using a multi-TAG configuration or a single-TAG configuration based at least in part on PCIs associated with the first CORESET pool index value and the second CORESET pool index value.

Some aspects described herein relate to a method of wireless communication performed by a UE. The method may include receiving an indication of a set of TAG IDs and associated PCIs of a network on a first serving cell having a first PCI. The method may include communicating with the network using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Some aspects described herein relate to a method of wireless communication performed by a network node. The method may include transmitting an indication of a first CORESET pool index value and a second CORESET pool index value associated with a serving cell of a network having a first PCI. The method may include transmitting an indication of a first TAG ID and a second TAG ID associated with the serving cell, wherein the first TAG is associated with the first CORESET pool index value and the second TAG is associated with the second CORESET pool index value. The method may include transmitting, from the serving cell, an indication of one or more additional PCIs different from the first PCI. The method may include communicating with a UE on the serving cell using a multi-TAG configuration or a single-TAG configuration based at least in part on PCIs associated with the first CORESET pool index value and the second CORESET pool index value.

Some aspects described herein relate to a method of wireless communication performed by a network node. The method may include transmitting an indication of a set of TAG IDs and associated PCIs of a network on a first serving cell having a first PCI. The method may include communicating with a UE using one or more TAGS based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Some aspects described herein relate to a UE for wireless communication. The UE may include a memory and one or more processors coupled to the memory. The one or more processors may be configured to receive an indication of a first CORESET pool index value and a second CORESET pool index value associated with a serving cell of a network having a first PCI. The one or more processors may be configured to receive an indication of a first TAG ID and a second TAG ID associated with the serving cell, wherein the first TAG is associated with the first CORESET pool index value and the second TAG is associated with the second CORESET pool index value. The one or more processors may be configured to receive, from the serving cell, an indication of one or more additional PCIs different from the first PCI. The one or more processors may be configured to communicate with the network on the serving cell using a multi-TAG configuration or a single-TAG configuration based at least in part on PCIs associated with the first CORESET pool index value and the second CORESET pool index value.

Some aspects described herein relate to a UE for wireless communication. The UE may include a memory and one or more processors coupled to the memory. The one or more processors may be configured to receive an indication of a set of TAG IDs and associated PCIs of a network on a first serving cell having a first PCI. The one or more processors may be configured to communicate with the network using one or more TAGs based at least in part on one or more of: at least one of the one or more TAGs being associated with one or more additional PCIs, of the associated PCIs, that are each associated with one or more active TCI states, or the one or more TAGS being associated with one or more CORESET pool index values that are each associated with one or more active TCI states associated with the first PCI.

Some aspects described herein relate to a network node for wireless communication. The network node may include a memory and one or more processors coupled to the memory. The one or more processors may be configured to transmit an indication of a first CORESET pool index value and a second CORESET pool index value associated with a serving cell of a network having a first PCI. The one or more processors may be configured to transmit an indication of a first TAG ID and a second TAG ID associated with the serving cell, wherein the first TAG is associated with the first CORESET pool index value and the second TAG is associated with the second CORESET pool index value. The one or more processors may be configured to transmit, from the serving cell, an indication of one or more additional PCIs different from the first PCI. The one or more processors may be configured to communicate with a UE on the serving cell using a multi-TAG configuration or a single-TAG configuration based at least in part on PCIs associated with the first CORESET pool index value and the second CORESET pool index value.

Some aspects described herein relate to a network node for wireless communication. The network node may include a memory and one or more processors coupled to the memory. The one or more processors may be configured to transmit an indication of a set of TAG IDs and associated PCIs of a network on a first serving cell having a first PCI. The one or more processors may be configured to communicate with a UE using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Some aspects described herein relate to a non-transitory computer-readable medium that stores a set of instructions for wireless communication by a UE. The set of instructions, when executed by one or more processors of the UE, may cause the UE to receive an indication of a first CORESET pool index value and a second CORESET pool index value associated with a serving cell of a network having a first PCI. The set of instructions, when executed by one or more processors of the UE, may cause the UE to receive an indication of a first TAG ID and a second TAG ID associated with the serving cell, wherein the first TAG is associated with the first CORESET pool index value and the second TAG is associated with the second CORESET pool index value. The set of instructions, when executed by one or more processors of the UE, may cause the UE to receive, from the serving cell, an indication of one or more additional PCIs different from the first PCI. The set of instructions, when executed by one or more processors of the UE, may cause the UE to communicate with the network on the serving cell using a multi-TAG configuration or a single-TAG configuration based at least in part on PCIs associated with the first CORESET pool index value and the second CORESET pool index value.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to receive an indication of a set of TAG IDs and associated PCIs of a network on a first serving cell having a first PCI. The set of instructions, when executed by one or more processors of the one or more instructions that, when executed by one or more processors of a UE, may cause the one or more instructions that, when executed by one or more processors of a UE to communicate with the network using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Some aspects described herein relate to a non-transitory computer-readable medium that stores a set of instructions for wireless communication by a network node. The set of instructions, when executed by one or more processors of the network node, may cause the network node to transmit an indication of a first CORESET pool index value and a second CORESET pool index value associated with a serving cell of a network having a first PCI. The set of instructions, when executed by one or more processors of the network node, may cause the network node to transmit an indication of a first TAG ID and a second TAG ID associated with the serving cell, wherein the first TAG is associated with the first CORESET pool index value and the second TAG is associated with the second CORESET pool index value. The set of instructions, when executed by one or more processors of the network node, may cause the network node to transmit, from the serving cell, an indication of one or more additional PCIs different from the first PCI. The set of instructions, when executed by one or more processors of the network node, may cause the network node to communicate with a UE on the serving cell using a multi-TAG configuration or a single-TAG configuration based at least in part on PCIs associated with the first CORESET pool index value and the second CORESET pool index value.

Some aspects described herein relate to a non-transitory computer-readable medium that stores a set of instructions for wireless communication by a network node. The set of instructions, when executed by one or more processors of the network node, may cause the network node to transmit an indication of a set of TAG IDs and associated PCIs of a network on a first serving cell having a first PCI. The set of instructions, when executed by one or more processors of the network node, may cause the network node to communicate with a UE using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Some aspects described herein relate to an apparatus for wireless communication. The apparatus may include means for receiving an indication of a first CORESET pool index value and a second CORESET pool index value associated with a serving cell of a network having a first PCI. The apparatus may include means for receiving an indication of a first TAG ID and a second TAG ID associated with the serving cell, wherein the first TAG is associated with the first CORESET pool index value and the second TAG is associated with the second CORESET pool index value. The apparatus may include means for receiving, from the serving cell, an indication of one or more additional PCIs different from the first PCI. The apparatus may include means for communicating with the network on the serving cell using a multi-TAG configuration or a single-TAG configuration based at least in part on PCIs associated with the first CORESET pool index value and the second CORESET pool index value.

Some aspects described herein relate to an apparatus for wireless communication. The apparatus may include means for receiving an indication of a set of TAG IDs and associated PCIs of a network on a first serving cell having a first PCI. The apparatus may include means for communicating with the network using one or more TAGs based at least in part on one or more of, at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Some aspects described herein relate to an apparatus for wireless communication. The apparatus may include means for transmitting an indication of a first CORESET pool index value and a second CORESET pool index value associated with a serving cell of a network having a first PCI. The apparatus may include means for transmitting an indication of a first TAG ID and a second TAG ID associated with the serving cell, wherein the first TAG is associated with the first CORESET pool index value and the second TAG is associated with the second CORESET pool index value. The apparatus may include means for transmitting, from the serving cell, an indication of one or more additional PCIs different from the first PCI. The apparatus may include means for communicating with a UE on the serving cell using a multi-TAG configuration or a single-TAG configuration based at least in part on PCIs associated with the first CORESET pool index value and the second CORESET pool index value.

Some aspects described herein relate to an apparatus for wireless communication. The apparatus may include means for transmitting an indication of a set of TAG IDs and associated PCIs of a network on a first serving cell having a first PCI. The apparatus may include means for communicating with a UE using one or more TAGs based at least in part on one or more of, at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a UE in a wireless network, in accordance with the present disclosure.

FIG. 3 is a diagram illustrating an example disaggregated base station architecture, in accordance with the present disclosure.

FIG. 4 illustrates an example logical architecture of a distributed RAN, in accordance with the present disclosure.

FIG. 5 is a diagram illustrating an example of multi-TRP communication (sometimes referred to as multi-panel communication), in accordance with the present disclosure.

FIG. 6 is a diagram illustrating an example of TRP differentiation at a UE based at least in part on a CORESET pool index, in accordance with the present disclosure.

FIG. 7 is a diagram illustrating an example of downlink and uplink transmissions between a network node (e.g., a TRP) and a UE in a wireless network, in accordance with the present disclosure.

FIG. 8 is a diagram of an example associated with TAGs for multiple PCI networks, in accordance with the present disclosure.

FIG. 9 is a diagram of examples associated with TAGs for multiple PCI networks, in accordance with the present disclosure.

FIG. 10 is a diagram of examples associated with TAGs for multiple PCI networks, in accordance with the present disclosure.

FIG. 11 is a diagram of examples associated with TAGs for multiple PCI networks, in accordance with the present disclosure.

FIG. 12 is a diagram illustrating an example process performed, for example, by a UE, in accordance with the present disclosure.

FIG. 13 is a diagram illustrating an example process performed, for example, by a UE, in accordance with the present disclosure.

FIG. 14 is a diagram illustrating an example process performed, for example, by a network node, in accordance with the present disclosure.

FIG. 15 is a diagram illustrating an example process performed, for example, by a network node, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

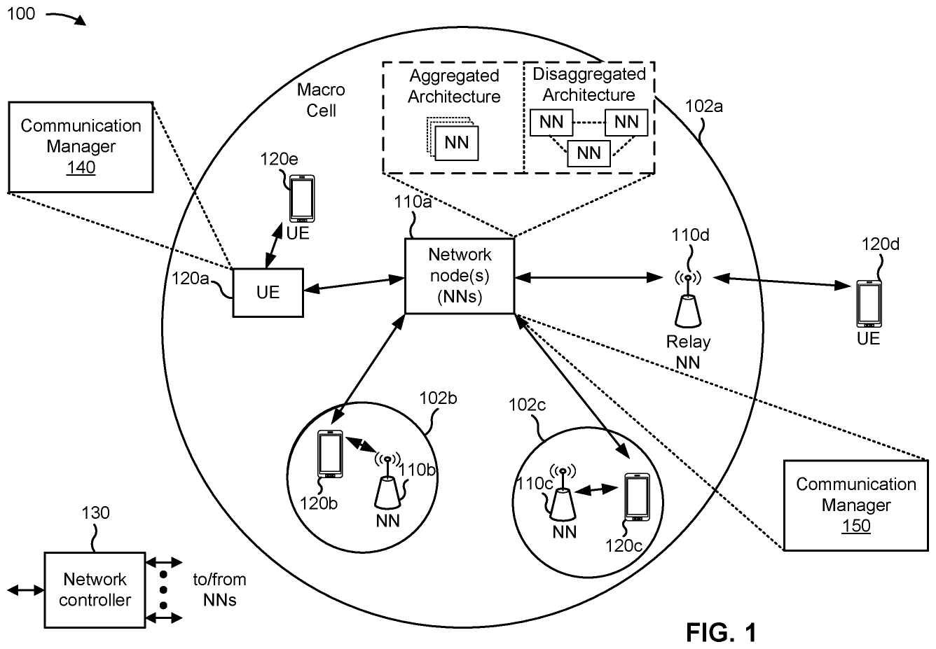

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a first control resource set (CORESET) pool index value and a second CORESET pool index value associated with a serving cell of a network having a first physical cell identifier (PCI); receive an indication of a first timing advance group (TAG) identifier (ID) and a second TAG ID associated with the serving cell, wherein the first TAG is associated with the first CORESET pool index value and the second TAG is associated with the second CORESET pool index value; receive, from the serving cell, an indication of one or more additional PCIs different from the first PCI; and communicate with the network on the serving cell using a multi-TAG configuration or a single-TAG configuration based at least in part on PCIs associated with the first CORESET pool index value and the second CORESET pool index value. Additionally, or alternatively, the communication manager 140 may perform one or more other operations described herein.

In some aspects, as described in more detail elsewhere herein, the communication manager 140 may receive an indication of a set of TAG IDs and associated PCIs of a network on a first serving cell having a first PCI; and communicate with the network using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI. Additionally, or alternatively, the communication manager 140 may perform one or more other operations described herein.

In some aspects, the network node 110 may include a communication manager 150. As described in more detail elsewhere herein, the communication manager 150 may transmit an indication of a first CORESET pool index value and a second CORESET pool index value associated with a serving cell of a network having a first PCI; transmit an indication of a first TAG ID and a second TAG ID associated with the serving cell, wherein the first TAG is associated with the first CORESET pool index value and the second TAG is associated with the second CORESET pool index value; transmit, from the serving cell, an indication of one or more additional PCIs different from the first PCI; and communicate with a UE on the serving cell using a multi-TAG configuration or a single-TAG configuration based at least in part on PCIs associated with the first CORESET pool index value and the second CORESET pool index value. Additionally, or alternatively, the communication manager 150 may perform one or more other operations described herein.

In some aspects, as described in more detail elsewhere herein, the communication manager 150 may transmit an indication of a set of TAG IDs and associated PCIs of a network on a first serving cell having a first PCI; and communicate with a UE using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI. Additionally, or alternatively, the communication manager 150 may perform one or more other operations described herein.

As indicated above, FIG. 1 is provided as an example. Other examples may differ from what is described with regard to FIG. 1.

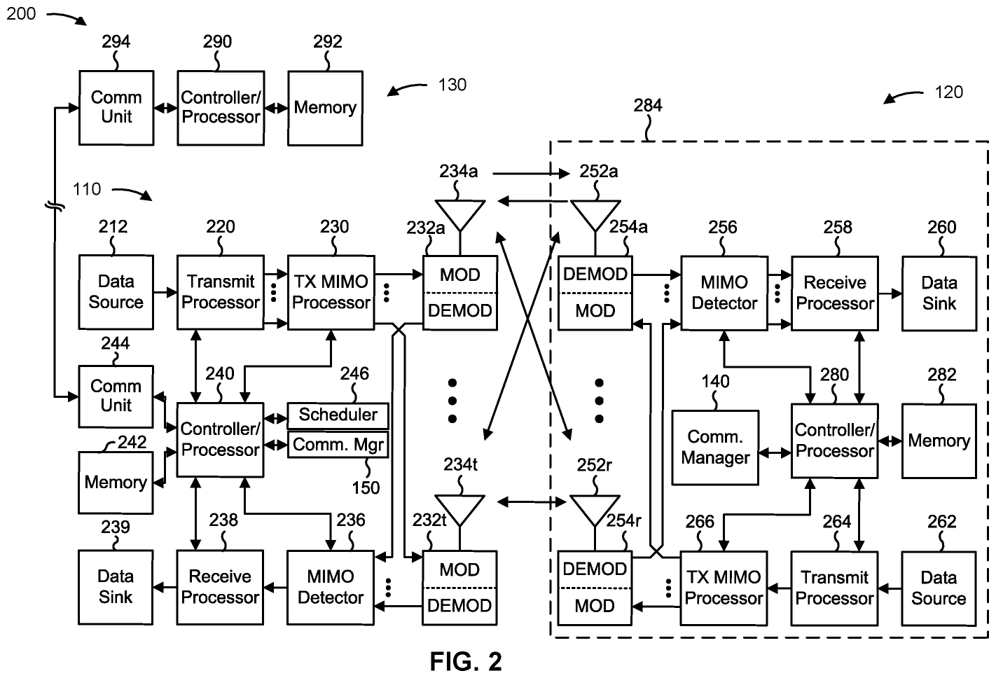

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

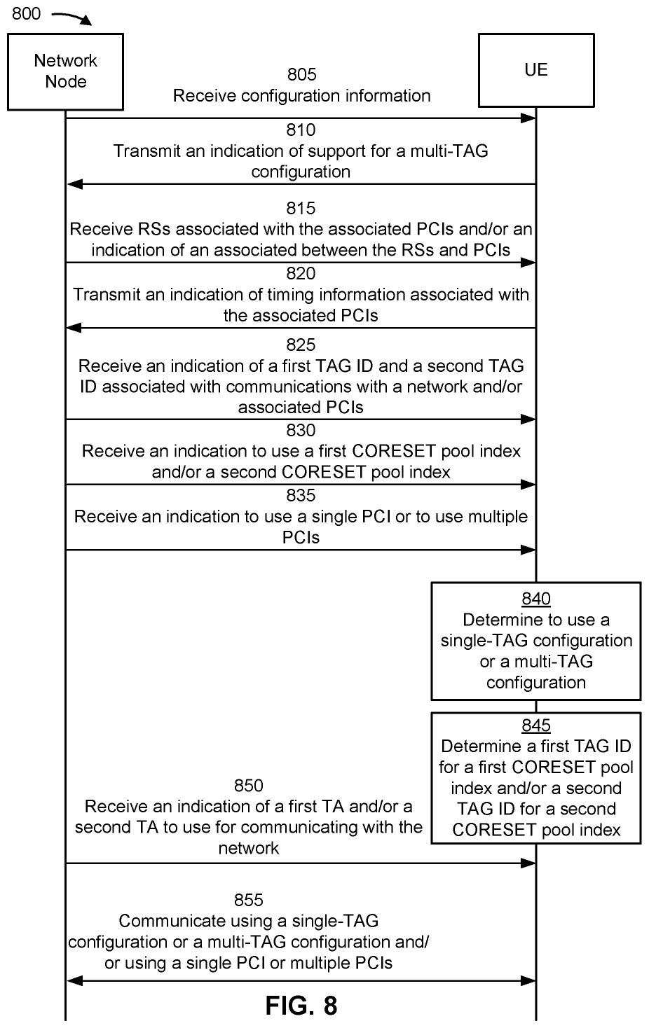

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-17).

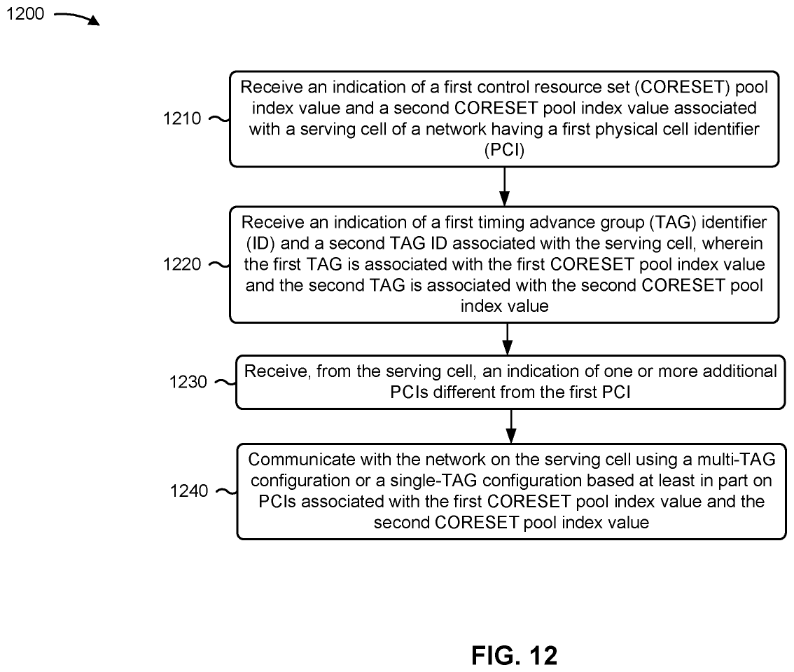

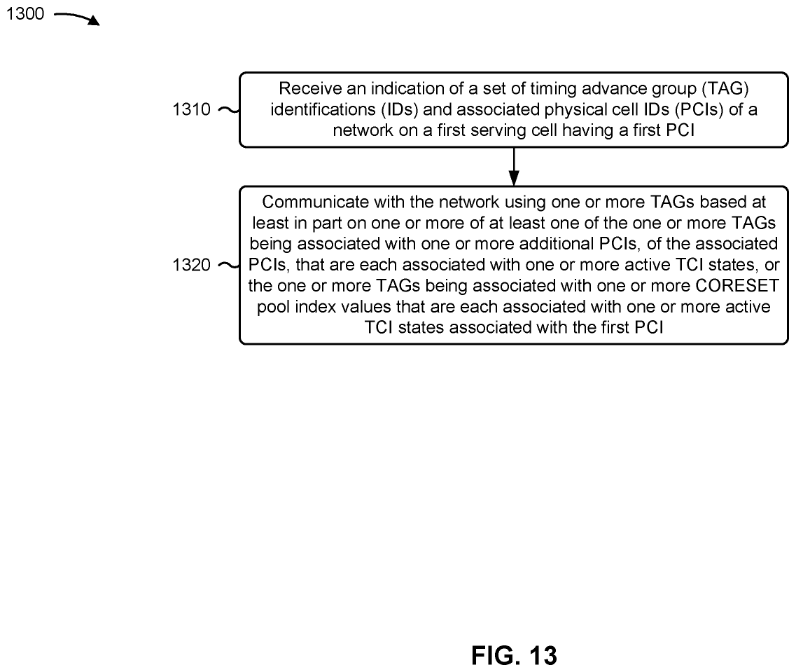

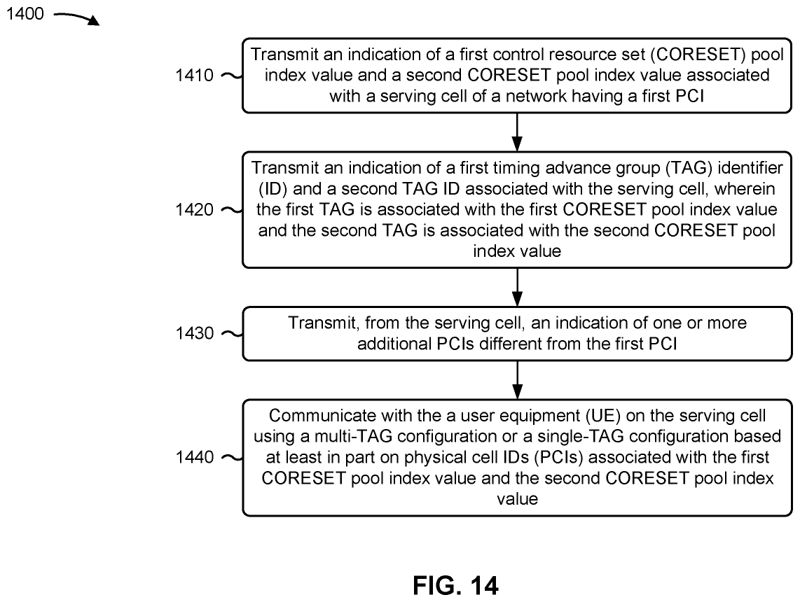

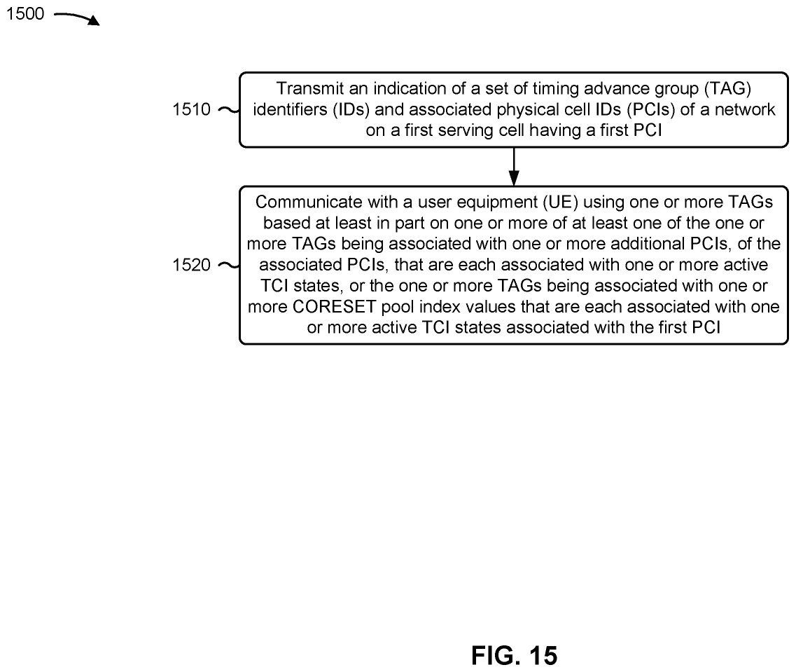

The controller/processor 240 of the network node 110, the controller/processor 280 of the UE 120, and/or any other component(s) of FIG. 2 may perform one or more techniques associated with TAGs for multiple PCI networks, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, the UE includes means for receiving an indication of a first CORESET pool index value and a second CORESET pool index value associated with a serving cell of a network having a first PCI; means for receiving an indication of a first TAG ID and a second TAG ID associated with the serving cell, wherein the first TAG is associated with the first CORESET pool index value and the second TAG is associated with the second CORESET pool index value; means for receiving, from the serving cell, an indication of one or more additional PCIs different from the first PCI; and/or means for communicating with the network on the serving cell using a multi-TAG configuration or a single-TAG configuration based at least in part on PCIs associated with the first CORESET pool index value and the second CORESET pool index value. In some aspects, the UE includes means for receiving an indication of a set of TAG IDs and associated PCIs of a network on a first serving cell having a first PCI; and/or means for communicating with the network using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an indication of a first CORESET pool index value and a second CORESET pool index value associated with a serving cell of a network having a first PCI; means for transmitting an indication of a first TAG ID and a second TAG ID associated with the serving cell, wherein the first TAG is associated with the first CORESET pool index value and the second TAG is associated with the second CORESET pool index value; means for transmitting, from the serving cell, an indication of one or more additional PCIs different from the first PCI; and/or means for communicating with a UE on the serving cell using a multi-TAG configuration or a single-TAG configuration based at least in part on PCIs associated with the first CORESET pool index value and the second CORESET pool index value. In some aspects, the network node includes means for transmitting an indication of a set of TAG IDs and associated PCIs of a network on a first serving cell having a first PCI; and/or means for communicating with a UE using one or more TAGs based at least in part on one or more of: at least one of the one or more TAGs being associated with one or more additional PCIs, of the associated PCIs, that are each associated with one or more active TCI states, or the one or more TAGS being associated with one or more CORESET pool index values that are each associated with one or more active TCI states associated with the first PCI. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

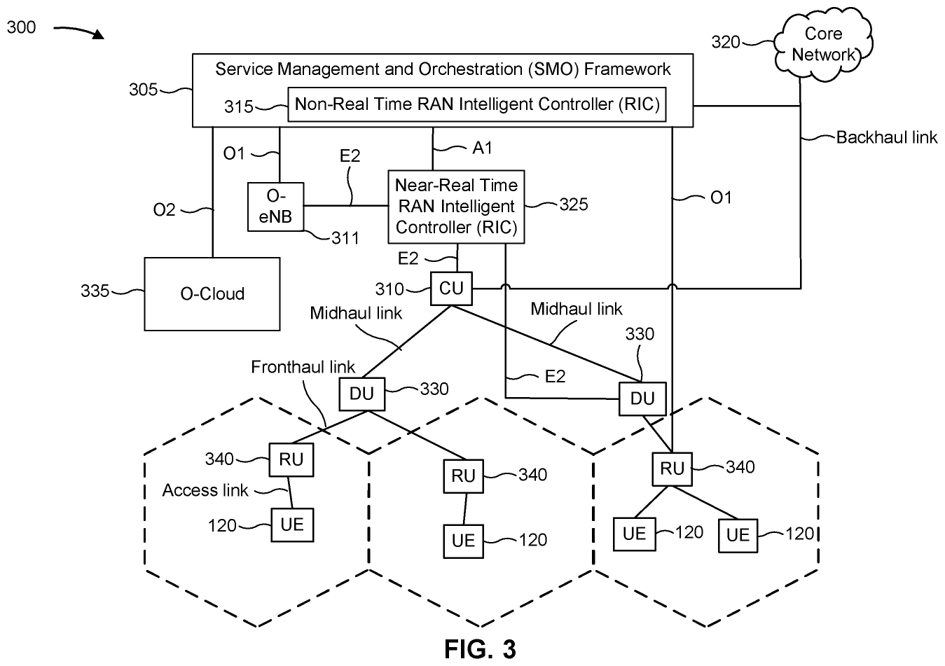

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

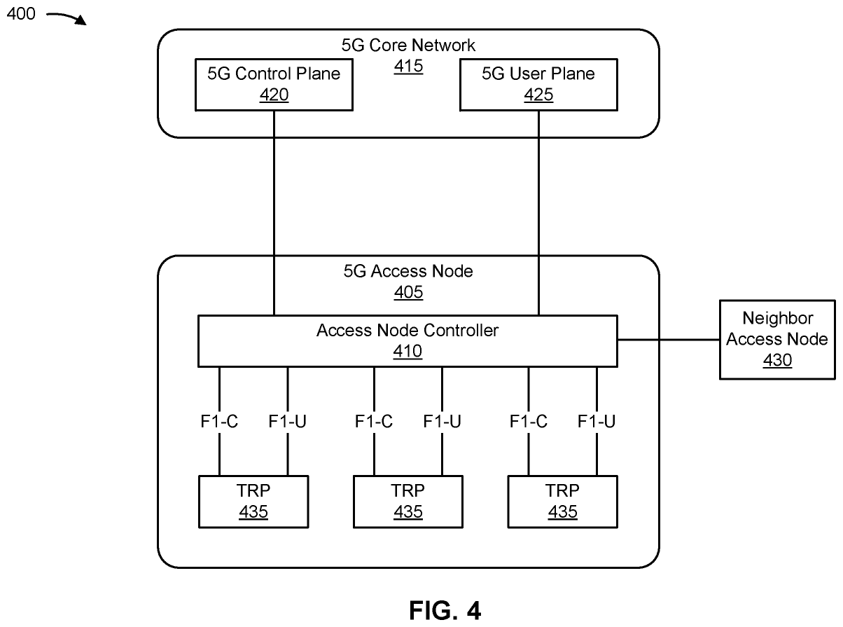

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a network node 110 described above in connection with FIG. 1. For example, different TRPs 435 may be included in different network node 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi-colocation (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE.

As indicated above, FIG. 4 is provided as an example. Other examples may differ from what was described with regard to FIG. 4.

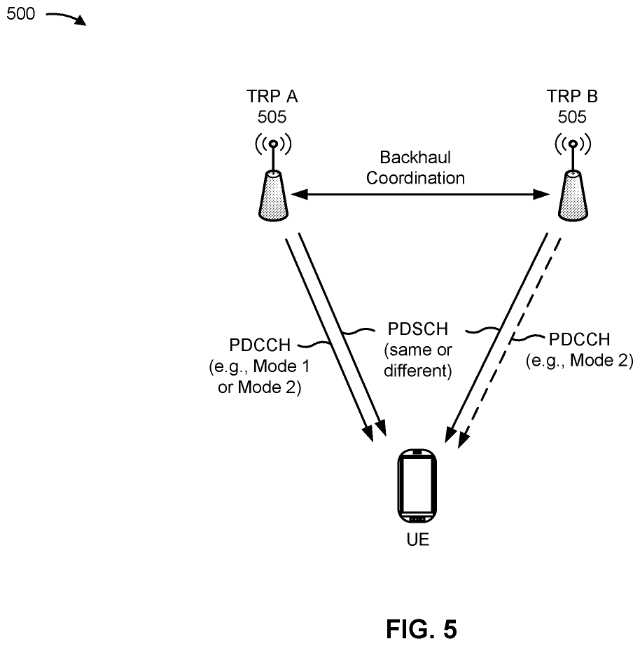

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE. A TRP 505 may correspond to a TRP 435 described above in connection with FIG. 4.

The multiple TRPs 505 (shown as TRP A and TRP B) may communicate with the same UE in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110) and may have a larger delay and/or lower capacity (as compared to co-location) when the TRPs 505 are located at different network nodes 110. The different TRPs 505 may communicate with the UE using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

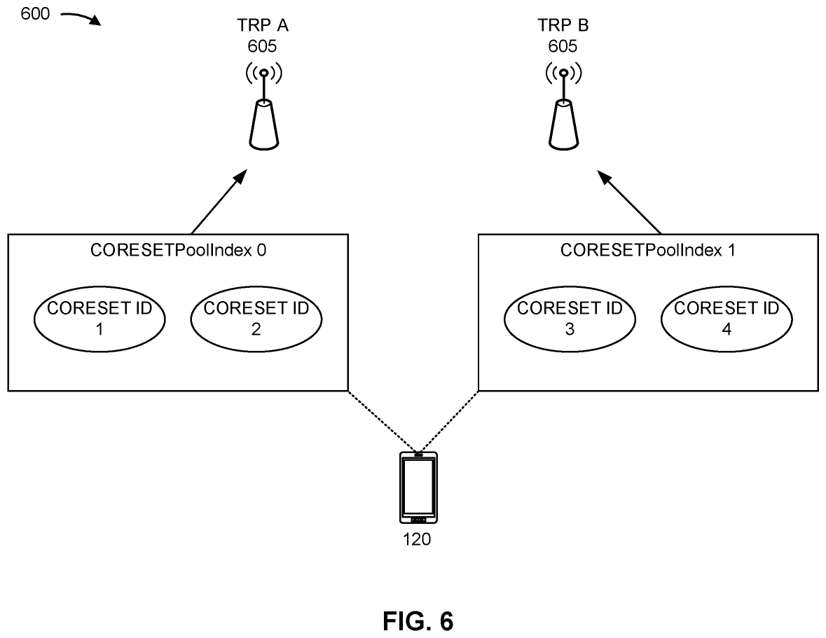

FIG. 6 is a diagram illustrating an example 600 of TRP differentiation at a UE based at least in part on a CORESET pool index, in accordance with the present disclosure. In some aspects, a CORESET pool index (or CORESETPoolIndex) value may be used by a UE (a UE) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE may be configured with multiple CORESETs in a given serving cell. Each CORESET configured for the UE may be associated with a CORESET identifier (CORESET ID). For example, a first CORESET configured for the UE may be associated with CORESET ID 1, a second CORESET configured for the UE may be associated with CORESET ID 2, a third CORESET configured for the UE may be associated with CORESET ID 3, and a fourth CORESET configured for the UE may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) may be associated with CORESET pool index 0 and a second TRP 605 (TRP B) may be associated with CORESET pool index 1. The UE may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

As indicated above, FIG. 6 is provided as an example. Other examples may differ from what is described with respect to FIG. 6.

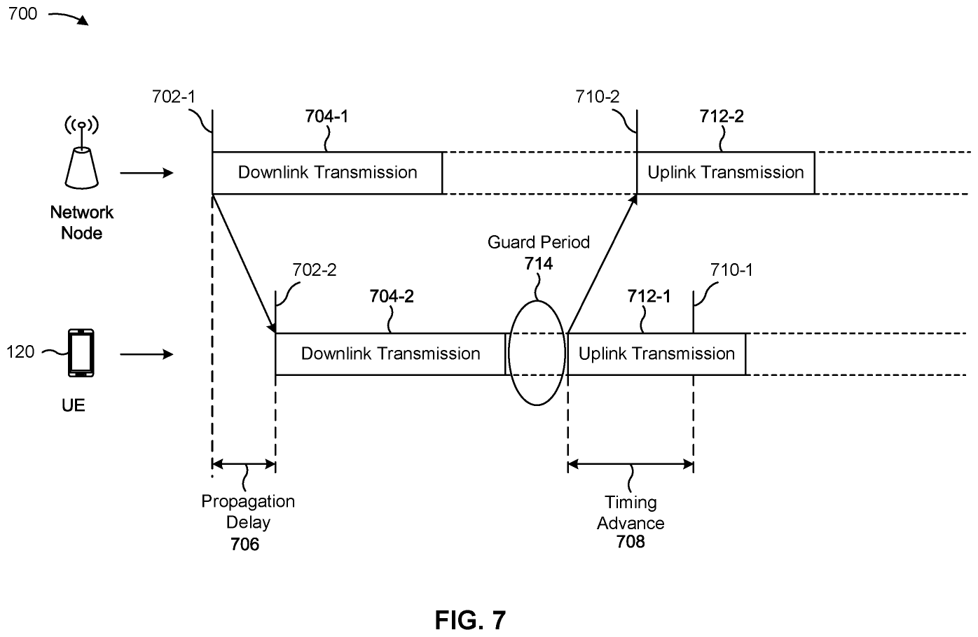

FIG. 7 is a diagram illustrating an example 700 of downlink and uplink transmissions between a network node (e.g., a TRP) and a UE in a wireless network, in accordance with the present disclosure. In some examples, the downlink and/or uplink transmissions are based at least in part on a timing advance and/or a guard period between communications. As one example, the network node (e.g., TRP) may configure a downlink transmission to end before the start of a guard period. As another example, the UE may advance a start time for an uplink transmission based at least in part on a timing advance.

As shown by reference number 702-1, the network node may begin a downlink transmission 704-1 to a UE at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 702-1 may be based at least in part on a time partition as defined by a telecommunication system (e.g., a frame, a subframe, a slot, a mini-slot, and/or a symbol).

In some examples, the network node and the UE may wirelessly communicate with one another based at least in part on the defined time partitions. However, each device may have different timing references for the time partitions. To illustrate, and as shown by the reference number 702-1, the network node may begin the downlink transmission 704-1 at a particular point in physical time that may be associated with a defined time partition based at least in part on a time perspective of the network node. For example, the network node may associate the particular point in physical time with a defined time partition, such as a beginning of a symbol, a beginning of a slot, a beginning of a subframe, and/or a beginning of a frame. However, the downlink transmission may incur a propagation delay 706 in physical time, such as a time delay based at least in part on the downlink transmission traveling between the network node and the UE. As shown by reference number 702-2, the UE may receive downlink transmission 704-2 (corresponding to downlink transmission 704-1 transmitted by the network node) at a second point in physical time that is later in time relative to the first point in physical time. From a time perspective of the UE, however, the UE may associate the second point in physical time shown by the reference number 702-2 with the same particular point in time of the defined time partition as the network node (e.g., a beginning of the same symbol, a beginning of the same mini-slot, a beginning of the same slot, a beginning of the same subframe, and/or a beginning of the same frame). Thus, as shown by the example 700, the time perspective of the UE may be delayed in physical time from the time perspective of the network node.

In wireless communication technologies like 4G/LTE and 5G/NR, a timing advance (TA) value is used to control a timing of uplink transmissions by a UE (e.g., UE and/or the like) such that the uplink transmissions are received by a network node (e.g., a TRP and/or an RU, among other examples) at a time that aligns with an internal timing of the network node. The network node may indicate the TA value to a UE by measuring a time difference between reception of uplink transmissions from the UE and a subframe timing used by the network node (e.g., by determining a difference between when the uplink transmissions were supposed to have been received by the network node, according to the subframe timing, and when the uplink transmissions were actually received), and by transmitting a TA command (TAC) to instruct the UE to transmit future uplink communications earlier or later to reduce or eliminate the time difference and align timing between the UE and network node. The TA command is used to offset timing differences between the UE and the network node due to different propagation delays that occur when the UE is different distances from the network node. If TA commands were not used, then uplink transmissions from different UEs (e.g., located at different distances from the network node) may collide due to mistiming even if the uplink transmissions are scheduled for different subframes.

To illustrate, without adjusting a start time of an uplink transmission, the UE may be configured to begin an uplink transmission at a scheduled point in time based at least in part on the defined time partitions as described elsewhere herein. As shown by reference number 710-1, a start of the scheduled point in time may occur at a third physical point in time based at least in part on the timing perspective of the UE. However, and as shown by reference number 710-2, the scheduled point in time with reference to the timing perspective of the network node may occur at a fourth point in physical time that occurs before the third point in physical time as shown by the reference number 710-1. Accordingly, the network node may instruct the UE to apply a timing advance 708 to an uplink transmission to better align reception of the uplink transmission with the timing perspective of the network node. However, in some examples, the fourth point in time shown by the reference number 710-2 may occur at or near a same physical point in time as the third point in time shown by the reference number 710-1 such that uplink transmissions from the UE to the network node incur the propagation delay 706. In such a scenario, the network node may instruct the UE to apply a timing advance with a time duration corresponding to the propagation delay 706.

As shown by the example 700, the UE may adjust a start time of an uplink transmission 712-1 based at least in part on the timing advance 708 and the start of the scheduled point in time (e.g., at the third physical point in time shown by the reference number 710-1). Based at least in part on propagation delay, the network node may receive an uplink transmission 712-2 (corresponding to the uplink transmission 712-1 transmitted by the UE) at the fourth point in physical time shown by the reference number 710-2.

In some examples, a timing advance value may be based at least in part on twice an estimated propagation delay (e.g., the propagation delay 706) and/or may be based at least in part on a round trip time (RTT). The network node may estimate the propagation delay and/or select a timing advance value based at least in part on communications with the UE. As one example, the network node may estimate the propagation delay based at least in part on a network access request message from the UE. Additionally, or alternatively, the network node may estimate and/or select the timing advance value from a set of fixed timing advance values.

In some examples, a telecommunication system and/or telecommunication standards may define a guard period 714 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 714 may sometimes be referred to as a gap, a switching guard period, or a guard interval.

In some examples, a transmitting device (e.g., the network node, a CU, a DU, and/or an RU) may select a starting transmission time and/or a transmission time duration based at least in part on a receiving device and/or the guard period. For example, the network node may select an amount of content (e.g., data and/or control information) to transmit in the downlink transmission 704-1 based at least in part on beginning the transmission at the first point in physical time shown by the reference number 702-1 and/or the UE completing reception of the downlink transmission 704-2 prior to a starting point of the guard period 714. Alternatively, or additionally, the UE may select an amount of content (e.g., data and/or control information) to transmit in the uplink transmission 712-1 based at least in part on the timing advance 708, the third point in physical time shown by the reference number 710-1, and/or refraining from beginning the uplink transmission 712-1 until the guard period 714 has ended.

As indicated above, FIG. 7 is provided as an example. Other examples may differ from what is described with regard to FIG. 7.

As described above, in a multi-DCI based configuration of a multi-TRP transmission, a first DCI (transmitted from TRP1) schedules PDSCH1 (transmitted from TRP1) and a second DCI (transmitted from TRP2) schedules PDSCH2 (transmitted from TRP2). The UE may differentiate TRP1 from TRP2 based at least in part on CORESET pool indexes (e.g., values of CORESETPoolIndex). Each CORESET (e.g., with a maximum of 5 CORESETs) may be configured with a value of CORESETPoolIndex. The value of CORESETPoolIndex may be 0 or 1, which may group CORESETs into two groups. Other than CORESETPoolIndex values, differences of TRPs are transparent to the UE.

The UE may be configured with multi-DCI based multi-TRP in a given component carrier based at least in part on whether the UE is configured by higher layer parameter PDCCH-Config that contains two different values of CORESETPoolIndex in CORESET's for an active bandwidth part (BWP) of a serving cell.

Different TRPs can have a same PCI (e.g., intra-cell TRPs) with different panels and/or remote radio heads (RRHs) of the same cell and/or network node.

Alternatively, different TRPs can have different PCIs (e.g., inter-cell TRPs). Note that in this case, from a perspective of the UE, multi-TRP is still defined in a given serving cell, but the UE is aware of only one PCI (e.g., the PCI that the UE acquired during a cell search).

A UE may be configured (e.g., RRC configured) with a list of up to M candidate TCI states at least for the purposes of QCL indications (e.g., M=128). The UE may be configured via the serving cell with a single TCI state list for all PCIs. The TCI states may be configured and/or defined in a configuration message (e.g., PDSCH-Config), and a TCI state ID (e.g., TOI-StateId) may be used for configuring the TCI states for a CORESET, a non-zero-power (NZP) channel state information reference signals (CSI-RSs) resource, physical uplink shared channel (PUCCH) resources, and/or sounding reference signal (SRS) resources, among other examples. A medium access control (MAC) control element (CE) may be used to activate up to 2^{N} TCI states out of M for a PDSCH QCL indication for a given CORESETPoolIndex. For a PDCCH, the MAC CE may activate one TCI state.

N bits in DCI may dynamically indicate the TCI state for the PDSCH transmission (e.g., N=3). For multi-DCI based multi-TRP, the PDSCH may be associated with the CORESETPoolIndex value of the CORESET in which the UE receives the DCI.

In some networks, a configuration message associated with the TCI states may indicate a CORESET pool ID, a serving cell ID, a BWP ID, and/or a set of TCI states associated with the indicated CORESET pool ID, serving cell ID, and/or BWP ID.

Some networks may support inter-cell multi-TRP. In inter-cell multi-TRP, a maximum number of additional RRC-configured PCIs per component carrier may be denoted as X and may be reported as a UE capability. The UE may support two independent X values (X1, X2) that are reported as a UE capability for two different assumptions on an additional synchronization signal block (SSB) time domain position and periodicity with respect to a serving cell SSB. For example, X1 (e.g., case 1) may indicate a maximum number of configured additional PCIs when each configuration of SSB time domain positions and periodicity of the additional PCIs is the same as (e.g., identical to or within a threshold difference from) SSB time domain positions and periodicity of the serving cell PCI. X2 (e.g., case 2) may indicate a maximum number of configured additional PCIs when the configurations of SSB time domain positions and periodicity of the additional PCIs is not the same as the serving cell. In this way, case 1 and case 2 may not be enabled simultaneously.

From an RRC signaling perspective, a number of configured additional PCIs can be from a set of numbers {1, 2, 3, 4, 5, 6, 7}. The UE may report the UE capability with different values for FR1 and FR2 communications. Center frequencies, subcarrier spacing, and a system frame number (SFN) offset are assumed to be the same for SSBs from the serving cell and the configured SSBs with PCI different from the serving cell for inter-cell multi TRP operation.

In some networks, a new RRC indicator and/or signaling (e.g., re-index the non-serving cell) may be used to indicate the non-serving cell information that a TCI state and/or QCL information is associated with, where the new indicator and/or signaling is not an exact PCI value.

In inter-cell multi-TRP, an association between PCI and CORESETPoolIndex may be based at least in part on a configuration and/or a communication protocol. For example, the serving cell PCI may always associated with active TCI states and only one additional PCI may be associated with the active TCI states. For inter-cell multi-TRP, one PCI associated with one or more of activated TCI states for PDSCH and/or PDCCH may be associated with one CORESETPoolIndex, another PCI associated with one or more of activated TCI states for PDSCH and/or PDCCH may be associated with another CORESETPoolIndex.

For example, a TCI state list may be configured, with each TCI in the list being associated with a PCI (e.g., either the serving cell PCI or an additional PCI). The UE may receive a first TCI activation MAC CE for CORESETPoolIndex 0 and a second TCI activation MAC CE for CORESETPoolIndex 1.

In some networks, two TAs for uplink multi-DCI for multi-TRP operation may be specified. In this case, different TRPs may have different TA values. To support two TAs for multi-DCI multi-TRP, one option is to configure multiple TAG IDs for a serving cell if the serving cell is configured with two CORESETPoolIndex values.

In some scenarios, the UE may need to switch between using a single-TA configuration and using a multi-TA configuration. In a first example of inter-cell multi-DCI multi-TRP, one of the TRPs is associated with an additional PCI and the TRP associated with the additional PCI may switch if the additional PCI associated with the activated TCI states is changed. Based at least in part on a geographical position and antenna array directions, for some TRP pairs, an individual TA may be needed. For other TRP pairs, a single TA may be sufficient.

In a second example, when switching between intra-cell multi-DCI multi-TRP and inter-cell multi-DCI multi-TRP, one of the serving cell TRPs may be changed to another TRP associated with an additional PCI. When switching between intra-cell multi-TRP and inter-cell multi-TRP, propagation delays to different TRPs may be different. For some TRP pairs, individual TAs may be needed, while for some other TRP pairs, a single TA may be sufficient. To avoid TA problems that would otherwise cause communication error (e.g., based at least in part on a propagation delay causing inter-symbol interference and/or being greater than a cyclic prefix), the network may configure the UE with two TAG IDs and two TA indications in all scenarios. However, this may unnecessarily consume communication and network resources and cause communication overhead.

In some aspects described herein, a UE may use a multi-TAG configuration or a single-TAG configuration based at least in part on PCIs associated with a first CORESET pool index value and a second CORESET pool index value. In some aspects, the UE may use one or more TAGs based at least in part on at least one of the one or more TAGs being associated with one or more additional PCIs that are each associated with one or more active TCI states and/or the one or more TAGs being associated with one or more CORESET pool index values that are each associated with one or more active TCI states associated with the first PCI, among other examples.

In some networks, two TAG IDs are configured per serving cell and each TAG ID is associated with a CORESETPoolIndex value. An additional PCI may be associated with a TAG ID that is associated with the same CORESETPoolIndex value as the PCI.

If the UE is configured with two TAGs and one or more additional PCIs for a serving cell, once the PCI associated with one or more active TCI states that is associated with a CORESETPoolIndex value is switched from an additional PCI to a serving cell PCI (e.g., switched from inter-cell multi-TRP to intra-cell multi-TRP), the UE switches from a multi-TAG configuration to a single TAG configuration. This means that for inter-cell multi-TRP the UE maintains two TAGs, and for intra-cell multi-TRP the UE maintains a single TAG. In some aspects, whether the UE is to maintain two TAGs or a single TAG for intra-cell multi-TRP can be configured by RRC.

Additionally, or alternatively, if a single TAG is maintained for intra-cell multi-TRP (e.g., after switching from multiple tags), which TAG should be maintained may be defined based on fixed rule (e.g., in a communication protocol) or configured by RRC. For example, a TAG with a lowest TAG ID or associated with a lowest CORESETPoolIndex value may be used.

For a CORESETPoolIndex, if the PCI associated with one or more active TCI states is further switched from a serving cell PCI to an additional PCI which can be a same PCI or different PCI from a previous additional PCI (e.g., a switch from intra-cell back to inter-cell multi-TRP), then for the new additional PCI, the UE may start from a latest indicated TA. For example, before receiving an initial TA associated with the new additional PCI, the UE can continue with the latest indicated TA associated with a TAG ID that is associated with the new additional PCI. Once the UE receives an initial TA associated with the new additional PCI, the UE may set the TA for the new additional PCI based on the initial TA.

In some aspects, when the UE switches among different PCIs of a serving cell, the UE always maintains two TAG IDs for the serving cell, with each TAG ID associated with a CORESETPoolIndex value. Once switched (e.g., where the one or more active TCI states associated with a CORESETPoolIndex is updated by MAC CE and the PCI associated with the old one or more active TCI states and the new one or more active TCI states are different), a TAG ID associated with the

CORESETPoolIndex value that is associated with the PCI is used as the TAG ID of the active PCI for the TA update. Even if a single TA can be used for some PCIs, a network node may still indicate individual TAs to the UE for each PCI. The UE may apply the individual TA command, which includes a TAG ID, to the PCI that is associated with this TAG ID.

In some networks, two TAG IDs are configured per serving cell, with each TAG ID being associated with a CORESETPoolIndex value. The two TAG IDs are configured for a serving cell PCI. In this case, which TAG to use is determined based at least in part on the CORESETPoolIndex value associated with the one or more active TCI states associated with the serving cell PCI. Additionally, or alternatively, the network node may know associations between TAG IDs and each additional PCI.

In some aspects, each additional PCI may be configured with a TAG ID. When the UE switches among different PCIs of a serving cell, the UE determines the active TAG IDs based at least in part on the TAG ID associated with a CORESETPoolIndex value associated with one or more active TCI states associated with the serving cell PCI is active, or the TAG ID associated with the additional PCI associated with one or more active TCI states is active. If two PCIs (e.g., each associated with one or more active TCI states) are associated with the same TAG, the network node may indicate a single TA to the UE for both PCIs. The UE applies the TA command, which includes the same TAG ID, to both PCIs.

In some networks, the network node may not know associations between the additional PCIs and TAGs. The UE may measure downlink timing differences between different PCIs (e.g., at least one is the serving cell PCI) based at least in part on SSBs associated with each PCI. The UE may report the downlink timing differences and or associated information to the network. The network node may configure the TAGs for additional PCIs based at least in part on the report.

The UE may determine, for the serving cell PCI, which SSBs to use to measure the downlink timing for a given CORESETPoolIndex based at least in part on an indication of association with a CORESETPoolIndex value (e.g., via RRC signaling). If the DL timing difference between a given CORESETPoolIndex of a first serving cell and an additional PCI of a second serving cell is within a threshold, the TAG ID associated with the given CORESETPoolIndex value of the first serving cell may be applied to the additional PCI. In some aspects, the first serving cell and second serving cell can be the same or different. The threshold may be predefined (e.g., in a communication protocol) or configured. Difference thresholds may be defined or configured for downlink timing differences between PCIs within a same serving cell and across different serving cells.

For downlink timing difference information reporting, the UE may report the downlink timing difference periodically, semi-persistent, and/or aperiodically. The report may include indications of the CORESETPoolIndex, the first serving cell PCI, additional PCI, and/or downlink timing differences between the CORESETPoolIndex and the additional PCI. In some aspects, the report may include indications of the serving cell SSB index, the first serving cell PCI, an SSB index associated with an additional PCI, and a downlink timing difference between the serving cell SSB index and SSB index associated with the additional PCI. In some aspects, the report may include indications of the CORESETPoolIndex, the first serving cell PCI, the additional PCI, and whether the downlink timing difference between the CORESETPoolIndex and the additional PCI is beyond the threshold (e.g., satisfies the threshold).

In some aspects, the UE may determine the TAG ID for an additional PCI based at least in part on the measured downlink timing difference and then report the TAG ID and an associated additional PCI.

In some aspects, when a downlink timing difference is reported, the UE may report the downlink timing difference regardless of whether the downlink timing difference is beyond the threshold. Alternatively, the UE may report the downlink timing difference only when the downlink timing difference is beyond the threshold. Additionally, or alternatively, the UE may report the downlink timing difference only when the downlink timing difference is within the threshold.

The UE and the network node may conserve network and communication resources that may otherwise be used to configure the UE with two TAG IDs and two TA indications in all scenarios. For example, the UE and the network node communicating with a number of TAGs that are based at least in part on a configuration and/or a communication protocol associated with PCIs associated with a first CORESET pool index value and a second CORESET pool index value, the one or more TAGs being associated with one or more additional PCIs that are each associated with one or more active TCI states, and/or the one or more TAGs being associated with one or more CORESET pool index values that are each associated with one or more active TCI states associated with the first PCI.

FIG. 8 is a diagram of an example 800 associated with TAGs for multiple PCI networks, in accordance with the present disclosure. As shown in FIG. 8, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 8. In the context of FIG. 8, the network node and the UE may communicate directly or indirectly (e.g., via one or more TRPs). The network node may be associated with a serving cell and/or one or more additional PCIs.

As shown by reference number 805, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit an indication of support for a multi-TAG configuration. In some aspects, the configuration information may indicate that the UE is to use a single-TAG configuration based at least in part on satisfaction of a first parameter or to use a multi-TAG configuration based at least in part on satisfaction of a second parameter.

The UE may configure itself based at least in part on the configuration information. In some aspects, the UE may be configured to perform one or more operations described herein based at least in part on the configuration information. In some aspects, the configuration information may indicate a configuration for using a multi-TAG configuration or a single TAG configuration based at least in part on the first CORESET pool index and the second CORESET pool index being associated with the first PCI. For example, the configuration information may indicate parameters for selecting a single-TAG or a multi-TAG configuration. In some aspects, the configuration information may indicate that for intra-cell multi-TRP, the UE is to maintain a single TAG.

As shown by reference number 810, the UE may transmit, and the network node may receive, an indication of support for a multi-TAG configuration.

As shown by reference number 815, the UE may receive, and the network node may transmit, reference signals (RSs) associated with the associated PCIs and/or an indication of an associated between the RSs and PCIs. In some aspects, the UE may measure the RSs and/or determine a propagation delay based at least in part on reception times of the RSs. In some aspects, the UE may receive an indication of associations between the RSs and the associated PCIs (e.g., in connection with reference number 805 and/or 815).

As shown by reference number 820, the UE may transmit, and the network node may receive, an indication of timing information associated with the associated PCIs.

In some aspects, the indication of the downlink reception timing information may include an indication of a downlink reception timing difference associated with a CORESET pool index value of a third PCI and a second PCI. In some aspects, the indication of the downlink reception timing information may include an indication of a downlink reception timing difference between a first reference signal and a second reference signal. In some aspects, the indication of the downlink reception timing information may include an indication of satisfaction or unsatisfaction of a threshold downlink reception timing difference between a CORESET pool index value of the third PCI and the second PCI or between the first reference signal and the second reference signal. In some aspects, the indication of the downlink reception timing information may include an indication of a TAG ID of the second PCI that is based at least in part on the downlink reception timing difference between the first reference signal and the second reference signal. In some aspects, the third PCI is associated with a second serving cell that is a same serving cell as the first serving cell and/or the third PCI is associated with the second serving cell that is different from the first serving cell.

In some aspects, the UE may transmit, and the network node may receive, an indication of downlink reception timing information associated with the associated PCIs.

As shown by reference number 825, the UE may receive, and the network node may transmit, an indication of a first TAG ID and a second TAG ID associated with communications with a network and/or associated PCIs. In some aspects, the UE may receive an indication of one or more additional PCIs different from the first PCI. In some aspects, the UE may receive the indication of the first TAG ID and the second TAG ID associated with communications with the network and/or associated PCIs based at least in part on transmission of the indication of the timing information associated with the associated PCIs.

In some aspects, the UE may receive an indication of a first TAG ID and a second TAG ID associated with a serving cell. The first TAG may be associated with the first CORESET pool index value and the second TAG may be associated with the second CORESET pool index value.

In some aspects, the UE may receive a first CORESET pool index value and a second CORESET pool index value associated with a serving cell of a network having a first PCI. In some aspects, multiple PCIs may be associated with the first CORESET pool index value and/or multiple PCIs may be associated with the second CORESET pool index value.

In some aspects, the UE may receive a first MAC CE indicating one or more active TCI states associated with the first PCI for a CORESET pool index value that was associated with a second PCI (e.g., a non-serving cell PCI).

In some aspects, the UE may receive an indication of a set of TAG IDs and associated PCIs of a network on a first serving cell having a first PCI. For example, the indication may map the PCIs to TAG IDs. The mapping may include mapping multiple PCIs to a single TAG ID (e.g., based at least in part on having similar propagation delays). For example, a first PCI may be associated with a TAG ID and a second PCI of one or more additional PCIs may be associated with the TAG ID. In some aspects, based at least in part on the first PCI and the second PCI being associated with the TAG ID, the UE may support reception and/or may receive an indication of a single TA for use in communicating with the network via the first PCI and via the second PCI. As shown by reference number 830, the UE may receive, and the network node may transmit, an indication to use a first CORESET pool index and/or a second CORESET pool index.

As shown by reference number 835, the UE may receive, and the network node may transmit, an indication to use a single PCI or to use multiple PCIs.

As shown by reference number 840, the UE may determine to use a single-TAG configuration or a multi-TAG configuration.

In some aspects, the UE may determine to use a multi-TAG configuration based at least in part on switching between using a first PCI for the first CORESET pool index value and a second PCI of the one or more additional PCIs for the second CORESET pool index value and using only the first PCI for both the first CORESET pool index value and the second CORESET pool index value. In some aspects, the UE may determine to use a multi-TAG configuration based at least in part on switching between using the first PCI for the first CORESET pool index value and the second PCI for the second CORESET pool index value and using the first PCI for the first CORESET pool index value and a third PCI for the second CORESET pool index value. In some aspects, using the first PCI for both the first CORESET pool index value and the second CORESET pool index value includes using a first TAG associated with a first CORESET pool index, and using a second TAG associated with a second CORESET pool index.

In some aspects, using the using the first PCI for the first CORESET pool index value and the second PCI for the second CORESET pool index value includes using the first TAG associated with the first CORESET pool index for the first PCI, and using the second TAG associated with the second CORESET pool index for the second PCI.

In some aspects, switching from using the first PCI for the first CORESET pool index value and the second PCI for the second CORESET pool index value to using the first PCI for the first CORESET pool index value and the third PCI for the second CORESET pool index value includes determining to communicate via the third PCI using a same TAG as used for the second PCI before switching.

In some aspects, the UE may determine to communicate using one or more TAGs based at least in part on at least one of the one or more TAGs being associated with one or more additional PCIs, of the associated PCIs, that are each associated with one or more active TCI states and/or the one or more TAGs being associated with one or more CORESET pool index values that are each associated with one or more active TCI states associated with the first PCI.

As shown by reference number 845, the UE may determine a first TAG ID for a first CORESET pool index and/or a second TAG ID for a second CORESET pool index.

In some aspects, the UE may select a first TAG ID or a second TAG ID for a single-TAG configuration based at least in part on one or more of a communication protocol or an indication from the network. For example, the UE may select the TAG ID from a set of TAG IDs that were configured for a multi-PCI ID configuration before switching to a single TAG ID configuration.

In some aspects, after switching from a multi-PCI to a single-PCT configuration, the UE may receive an indication to switch back to a multi-PCI configuration. For example, the UE may receive an indication of one or more active TCI states associated with a third PCI for the second CORESET pool index value that was associated with the first PCI during a single-PCI configuration. For example, for a CORESETPoolIndex, the PCI associated with one or more active TCI states may be further switched from a serving cell PCI to an additional PCI which can be a same or different PCT from the previous additional PCI. The UE may use, for communication with the network node, a TA of the second TAG to the second CORESET pool index value based at least in part on the TA being indicated for the second CORESET pool index during a previous multi-TAG configuration and based at least in part on an initial TA for the third PCI not being received. After receiving the initial TA associated with the third PCI for the second TAG, the UE may apply the initial TA associated with the third PCI for the second TAG associated with the second CORESET pool index.

As shown by reference number 850, the UE may receive, and the network node may transmit, an indication of a first TA and/or a second TA to use for communicating with the network. For example, the UE may receive an indication of a first TA for the first TAG and a second TA for the second TAG to use for communicating using the multi-TAG configuration. In some aspects, the UE may receive the indication based at least in part on the UE transmitting a report indicated timing information associated with different PCIs. In some aspects, a single TAG ID is associated with a first CORESET pool index value of a third PCI and a second PCI of the set of associated PCIs based at least in part on a difference of first timing information associated with the second PCI and second timing information associated with the third PCI satisfying a threshold. In some aspects, the UE may receive an indication of the threshold. In some aspects, the threshold applies to PCIs within a serving cell and/or the threshold applies to PCIs of different serving cells.

As shown by reference number 855, the UE and the network node may communicate using a single-TAG configuration or a multi-TAG configuration and/or using a single PCI or multiple PCIs. In some aspects, the UE and the network node may communicate on the serving cell using a multi-TAG configuration or a single-TAG configuration based at least in part on PCIs associated with the first CORESET pool index value and the second CORESET pool index value. In some aspects, the UE may communicate with the network node based at least in part on determinations described in connection with reference numbers 840 and 845, among other examples.

For example, the UE may communicate with the network (e.g., associated with the network node) on the serving cell using a multi-TAG configuration based at least in part on the first CORESET pool index value being associated with the first PCI and the second CORESET pool index value being associated with a second PCI from one of more additional PCIs.

In some aspects, the UE may communicate with the network on the serving cell using a single-TAG configuration in response to receiving a MAC CE indicating one or more active TCI states associated with the first PCI for the second CORESET pool index value that was associated with the second PCI before switching to the first PCI.

The UE and the network node may conserve network and communication resources that may otherwise be used to configure the UE with two TAG IDs and two TA indications in all scenarios. For example, the UE and the network node communicating with a number of TAGs that are based at least in part on a configuration and/or a communication protocol associated with PCIs associated with a first CORESET pool index value and a second CORESET pool index value, the one or more TAGs being associated with one or more additional PCIs that are each associated with one or more active TCI states, and/or the one or more TAGs being associated with one or more CORESET pool index values that are each associated with one or more active TCI states associated with the first PCI.

As indicated above, FIG. 8 is provided as an example. Other examples may differ from what is described with respect to FIG. 8. For example, operations shown in FIG. 8, and/or other figures shown herein, may be performed in a different order than what is shown in the figures, one or more of the operations may be omitted, and/or one or more additional operations may be performed between shown operations.

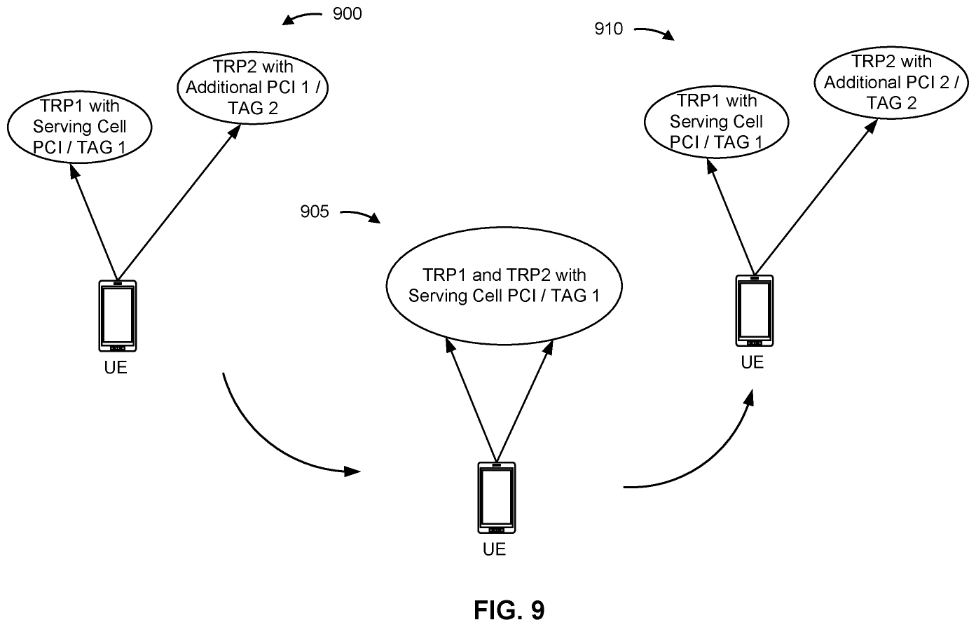

FIG. 9 is a diagram of examples 900, 905, and 910 associated with TAGs for multiple PCI networks, in accordance with the present disclosure. In context of FIG. 9, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 9. In the context of FIG. 9, the network node and the UE may communicate directly or indirectly (e.g., via one or more TRPs). The network node may be associated with a serving cell and/or one or more additional PCIs.

As shown by reference number 900, the UE may communicate with a first TRP (TRP1) with a serving cell PCI and a first TAG (TAG 1) and may communicate with a second TRP (TRP2) with a first additional PCI (additional PCI 1) and a second TAG (TAG 2).

As shown by reference number 905, the UE may switch to communicating via only the serving cell with a first TRP and a second TRP (e.g., one or more of the first TRP or the second TRP may be the same as the first TRP and the second TRP of 900) and with only TAG 1.

As shown by reference number 910, the UE may switch to communicating with a first TRP with the serving cell PCI and TAG 1 and may communicate with a second TRP (same or different from the TRP 2 of 900 or 905) with a second additional PCI (additional PCI 3) and TAG2.

As shown in FIG. 9, the UE may use a number of TAGs that is based at least in part on whether one PCI is active (e.g., for intra-cell multi-TRP) or multiple PCIs are active (e.g., for inter-cell multi-TRP). The UE may use a single TAG when only one PCI is active and may use multiple TAGs when multiple PCIs are active.

As indicated above, FIG. 9 is provided as an example. Other examples may differ from what is described with respect to FIG. 9.

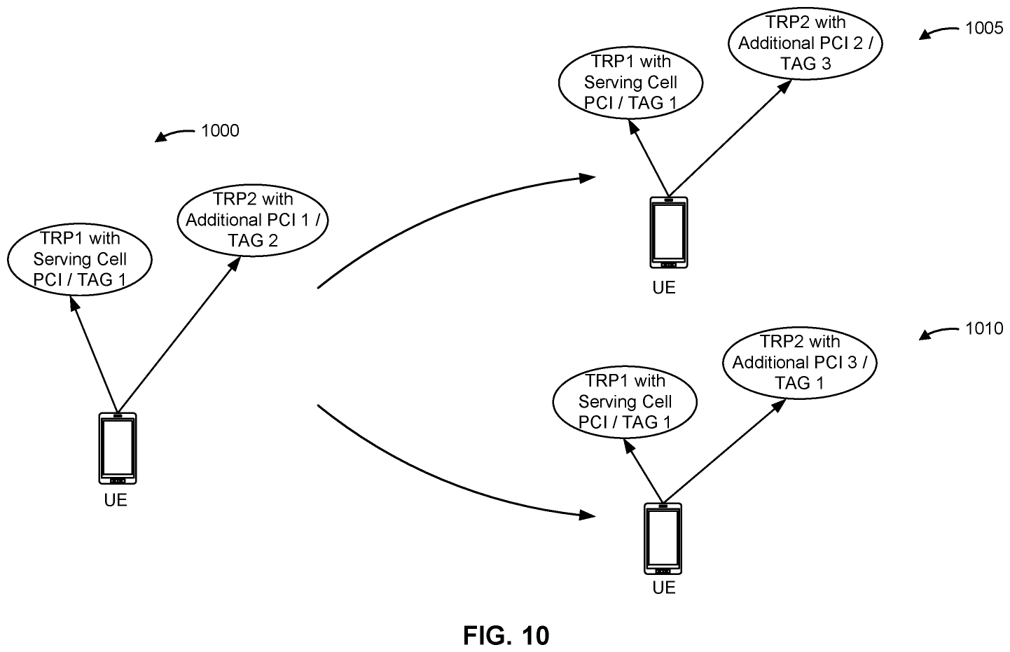

FIG. 10 is a diagram of examples 1000, 1005, and 1010 associated with TAGs for multiple PCI networks, in accordance with the present disclosure. In context of FIG. 10, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 10. In the context of FIG. 10, the network node and the UE may communicate directly or indirectly (e.g., via one or more TRPs). The network node may be associated with a serving cell and/or one or more additional PCIs.

As shown by reference number 1000, the UE may communicate with a first TRP with the serving cell PCI and a first TAG (TAG 1) and may communicate with a second TRP (TRP2) with a first additional PCI (additional PCI 1) and a second TAG (TAG 2).

As shown by reference number 1005, the UE may switch to communicating with the first TRP with a serving cell PCI and the TAG 1 and with a second TRP (e.g., different from the second TRP of 1000) with a second additional PCI (additional PCI 2) and a third TAG (TAG 3) (different from TAG 2). In this way, the UE may be configured to use a TAG that maps to an active PCI.

As shown by reference number 1010, the UE may switch to communicating with the first TRP with the serving cell PCI and the TAG 1 and with a second TRP (e.g., different from the second TRP of 1000 and/or 1005) with a third additional PCI (additional PCI 3) and TAG 1 (different from TAG 2). In this way, the UE may be configured to use a TAG that maps to an active PCI, even if multiple PCIs map to a same TAG. With the same TAG configured for the first TRP and the second TRP, the UE may receive a single TA for both TRPs.

As indicated above, FIG. 10 is provided as an example. Other examples may differ from what is described with respect to FIG. 10.

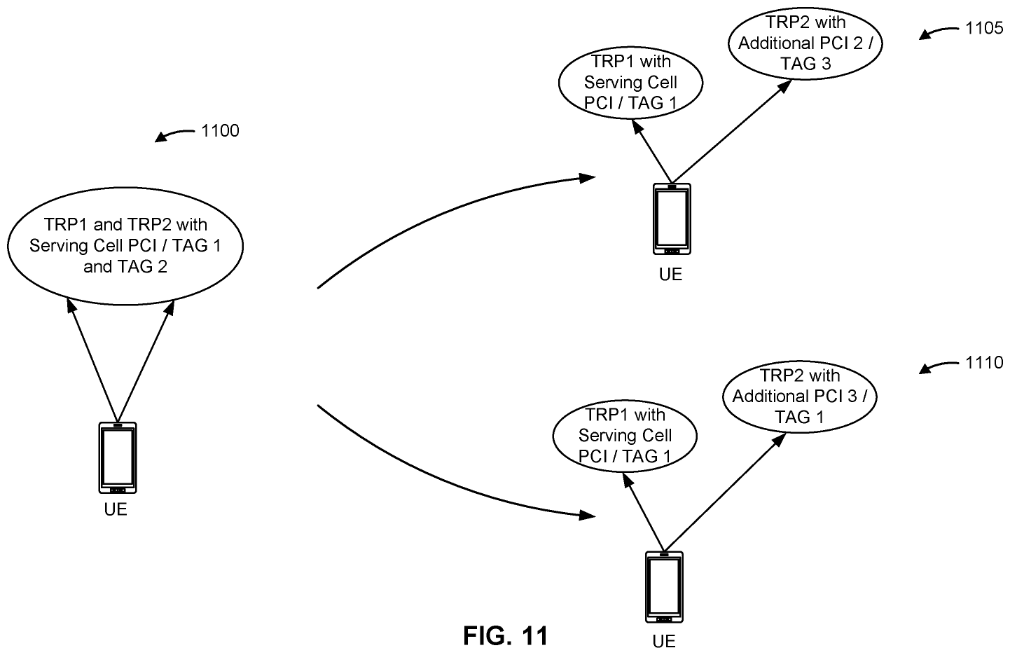

FIG. 11 is a diagram of examples 1100, 1105, and 1110 associated with TAGs for multiple PCI networks, in accordance with the present disclosure. In context of FIG. 11, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 11. In the context of FIG. 11, the network node and the UE may communicate directly or indirectly (e.g., via one or more TRPs). The network node may be associated with a serving cell and/or one or more additional PCIs.

As shown by reference number 1100, the UE may communicate with a first TRP with the serving cell PCI and TAG 1 and may communicate with a second TRP with the serving cell PCI and a second TAG.

As shown by reference number 1105, the UE may switch to communicating via the serving cell with a first TRP and with TAG 1 and via a second TRP with a second additional PCI and with TAG 3. For example, TAG 1 may be associated with (e.g., mapped to) the first TRP and TAG 3 may be associated with (e.g. mapped to) the second TRP. For example, the TAGs may be associated with the different TRPs via associated PCIs and/or via associated CORESET pool indexes.

As shown by reference number 1110, the UE may switch to communicating with the first TRP with the serving cell PCI and the TAG 1 and with a second TRP (e.g., different from the second TRP of 1100 and 1105) and with TAG 1 (different from TAG 3).

Reference number 1105 and 1110 may be alternatives. For example, the UE may communicate with the second TRP of PCI 2 with a TAG 3 based at least in part on a difference of timing information of the second TRP of PCI 2 and the first TRP of the serving cell failing to satisfy a threshold.

Alternatively, the UE may communicate with the second TRP of PCI 3 with the TAG 1 based at least in part on a difference of timing information of the second TRP of PCI 3 and the first TRP of the serving cell satisfying the threshold. Alternatively, the UE may communicate with the second TRP of PCI 2 with a TAG 3 based at least in part on the PCI 2 being mapped to the TAG 3 or the UE may communicate with the second TRP of PCI 3 with the TAG 1 based at least in part on the PCI 3 being mapped to the TAG 1.

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with TAGs for multiple PCI networks.

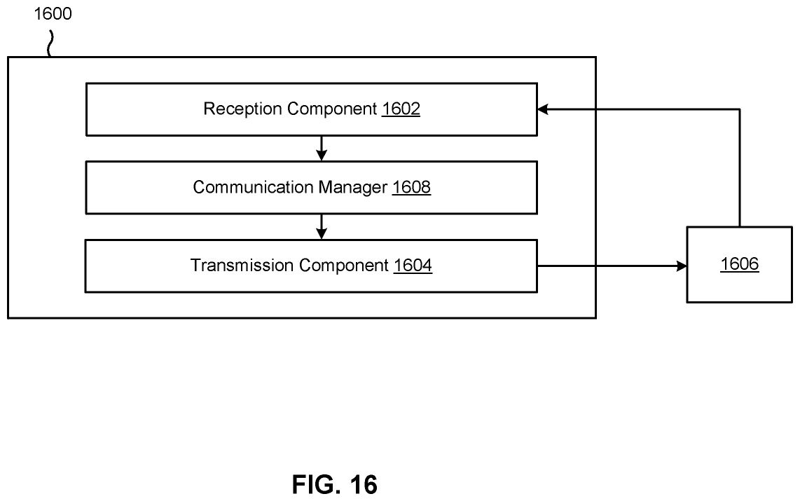

As shown in FIG. 12, in some aspects, process 1200 may include receiving an indication of a first CORESET pool index value and a second CORESET pool index value associated with a serving cell of a network having a first PCI (block 1210). For example, the UE (e.g., using communication manager 140 and/or reception component 1602, depicted in FIG. 16) may receive an indication of a first CORESET pool index value and a second CORESET pool index value associated with a serving cell of a network having a first PCI, as described above.

As further shown in FIG. 12, in some aspects, process 1200 may include receiving an indication of a first TAG ID and a second TAG ID associated with the serving cell, wherein the first TAG is associated with the first CORESET pool index value and the second TAG is associated with the second CORESET pool index value (block 1220). For example, the UE (e.g., using communication manager 140 and/or reception component 1602, depicted in FIG. 16) may receive an indication of a first TAG ID and a second TAG ID associated with the serving cell, wherein the first TAG is associated with the first CORESET pool index value and the second TAG is associated with the second CORESET pool index value, as described above.

As further shown in FIG. 12, in some aspects, process 1200 may include receiving, from the serving cell, an indication of one or more additional PCIs different from the first PCI (block 1230). For example, the UE (e.g., using communication manager 140 and/or reception component 1602, depicted in FIG. 16) may receive, from the serving cell, an indication of one or more additional PCIs different from the first PCI, as described above.

As further shown in FIG. 12, in some aspects, process 1200 may include communicating with the network on the serving cell using a multi-TAG configuration or a single-TAG configuration based at least in part on PCIs associated with the first CORESET pool index value and the second CORESET pool index value (block 1240). For example, the UE (e.g., using communication manager 140, reception component 1602 and/or transmission component 1604, depicted in FIG. 16) may communicate with the network on the serving cell using a multi-TAG configuration or a single-TAG configuration based at least in part on PCIs associated with the first CORESET pool index value and the second CORESET pool index value, as described above.

Process 1200 may include additional aspects, such as any single aspect or any combination of aspects described below and/or in connection with one or more other processes described elsewhere herein.

In a first aspect, communicating with the network on the serving cell using the multi-TAG configuration or the single-TAG configuration comprises communicating with the network on the serving cell using a multi-TAG configuration based at least in part on the first CORESET pool index value being associated with the first PCI and the second CORESET pool index value being associated with a second PCI from one of more additional PCIs.

In a second aspect, alone or in combination with the first aspect, process 1200 includes receiving a first MAC CE indicating one or more active TCI states associated with the first PCI for the second CORESET pool index value that was associated with the second PCI, and communicating with the network on the serving cell using a single-TAG configuration in response to receiving the first MAC CE.

In a third aspect, alone or in combination with one or more of the first and second aspects, process 1200 includes selecting the first TAG ID or the second TAG ID for the single-TAG configuration based at least in part on one or more of a communication protocol or an indication from the network.

In a fourth aspect, alone or in combination with one or more of the first through third aspects, process 1200 includes receiving an indication of one or more active TCI states associated with a third PCI of the one or more additional PCI for the second CORESET pool index value that was associated with the first PCI, and communicating using a TA of the second TAG to the second CORESET pool index value based at least in part on the TA being indicated for the second CORESET pool index during a previous multi-TAG configuration and based at least in part on an initial TA for the third PCI not being received.

In a fifth aspect, alone or in combination with one or more of the first through fourth aspects, process 1200 includes receiving an indication of the initial TA associated with the third PCI for the second TAG, and applying the initial TA associated with the third PCI for the second TAG associated with the second CORESET pool index.

In a sixth aspect, alone or in combination with one or more of the first through fifth aspects, process 1200 includes receiving an indication of a configuration for using a multi-TAG configuration or a single TAG configuration based at least in part on the first CORESET pool index and the second CORESET pool index being associated with the first PCI.

In a seventh aspect, alone or in combination with one or more of the first through sixth aspects, communicating with the network using the multi-TAG configuration or the single-TAG configuration comprises communicating using the multi-TAG configuration based at least in part on switching between using a first PCI for the first CORESET pool index value and a second PCI of the one or more additional PCIs for the second CORESET pool index value and using only the first PCI for both the first CORESET pool index value and the second CORESET pool index value, or switching between using the first PCI for the first CORESET pool index value and the second PCI for the second CORESET pool index value and using the first PCI for the first CORESET pool index value and a third PCI for the second CORESET pool index value.

In an eighth aspect, alone or in combination with one or more of the first through seventh aspects, using the first PCI for both the first CORESET pool index value and the second CORESET pool index value comprises using a first TAG associated with a first CORESET pool index, and using a second TAG associated with a second CORESET pool index.

In a ninth aspect, alone or in combination with one or more of the first through eighth aspects, using the first PCI for the first CORESET pool index value and the second PCI for the second CORESET pool index value comprises using the first TAG associated with the first CORESET pool index for the first PCI, and using the second TAG associated with the second CORESET pool index for the second PCI.

In a tenth aspect, alone or in combination with one or more of the first through ninth aspects, process 1200 includes communicating via the third PCI using a same TAG as used for the second PCI before switching.

In an eleventh aspect, alone or in combination with one or more of the first through tenth aspects, process 1200 includes receiving an indication of a first TA for the first TAG and a second TA for the second TAG to use for communicating using the multi-TAG configuration.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120) performs operations associated with TAGs for multiple PCI networks.

As shown in FIG. 13, in some aspects, process 1300 may include receiving an indication of a set of TAG IDs and associated PCIs of a network on a first serving cell having a first PCI (block 1310). For example, the UE (e.g., using communication manager 140 and/or reception component 1602, depicted in FIG. 16) may receive an indication of a set of TAG IDs and associated PCIs of a network on a first serving cell having a first PCI, as described above.

As further shown in FIG. 13, in some aspects, process 1300 may include communicating with the network using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI (block 1320). For example, the UE (e.g., using communication manager 140, reception component 1602, and/or transmission component 1604, depicted in FIG. 16) may communicate with the network using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI, as described above.

Process 1300 may include additional aspects, such as any single aspect or any combination of aspects described below and/or in connection with one or more other processes described elsewhere herein.

In a first aspect, the first PCI is associated with a TAG ID and a second PCI of one or more additional PCIs is associated with the TAG ID.

In a third aspect, alone or in combination with the first aspect, based at least in part on the first PCI and the second PCI being associated with the TAG ID, the UE supports reception of an indication of a single TA for use in communicating with the network via the first PCI and via the second PCI.

In a third aspect, alone or in combination with one or more of the first and second aspects, process 1300 includes receiving reference signals associated with the associated PCIs, and transmitting an indication of downlink reception timing information associated with the associated PCIs.

In a fourth aspect, alone or in combination with one or more of the first through third aspects, receiving the indication of the set of TAG IDs and associated PCIs is based at least in part on transmitting the indication of the downlink reception timing information associated with the associated PCIs.

In a fifth aspect, alone or in combination with one or more of the first through fourth aspects, process 1300 includes receiving an indication of associations between the reference signals and the associated PCIs.

In a sixth aspect, alone or in combination with one or more of the first through fifth aspects, transmitting the indication of the downlink reception timing information comprises transmitting the indication of the downlink reception timing information periodically, semi-persistently, or aperiodically.

In a seventh aspect, alone or in combination with one or more of the first through sixth aspects, the indication of the downlink reception timing information comprises one or more of an indication of a downlink reception timing difference associated with a CORESET pool index value of a third PCI and a second PCI, an indication of a downlink reception timing difference between a first reference signal and a second reference signal, an indication of satisfaction or unsatisfaction of a threshold downlink reception timing difference between a CORESET pool index value of the third PCI and the second PCI or between the first reference signal and the second reference signal, or an indication of a TAG ID of the second PCI that is based at least in part on the downlink reception timing difference between the first reference signal and the second reference signal.

In an eighth aspect, alone or in combination with one or more of the first through seventh aspects, the third PCI is associated with a second serving cell that is a same serving cell as the first serving cell, or the third PCI is associated with the second serving cell that is different from the first serving cell.

In a ninth aspect, alone or in combination with one or more of the first through eighth aspects, a single TAG ID is associated with a first CORESET pool index value of a third PCI and a second PCI of the set of associated PCIs based at least in part on a difference of first timing information associated with the second PCI and second timing information associated with the third PCI satisfying a threshold.

In a tenth aspect, alone or in combination with one or more of the first through ninth aspects, process 1300 includes receiving an indication of the threshold, wherein the threshold applies to PCIs within a serving cell, or wherein the threshold applies to PCIs of different serving cells.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with TAGs for multiple PCI networks.

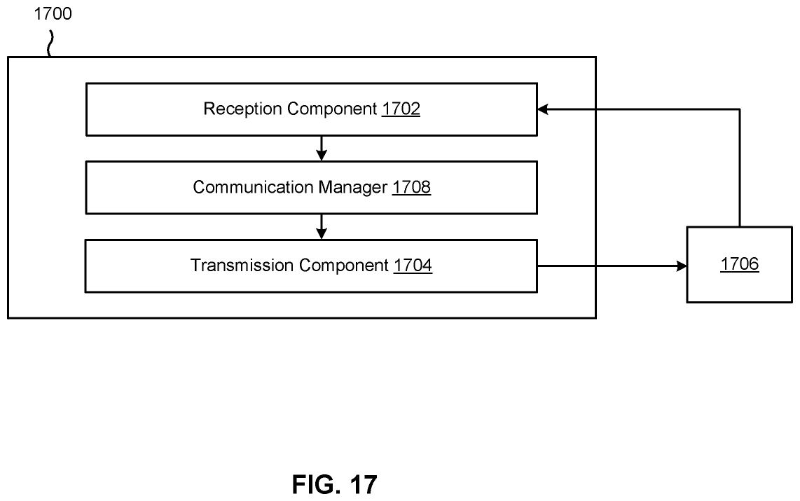

As shown in FIG. 14, in some aspects, process 1400 may include transmitting an indication of a first CORESET pool index value and a second CORESET pool index value associated with a serving cell of a network having a first PCI (block 1410). For example, the network node (e.g., using communication manager 150 and/or transmission component 1704, depicted in FIG. 17) may transmit an indication of a first CORESET pool index value and a second CORESET pool index value associated with a serving cell of a network having a first PCI, as described above.

As further shown in FIG. 14, in some aspects, process 1400 may include transmitting an indication of a first TAG ID and a second TAG ID associated with the serving cell, wherein the first TAG is associated with the first CORESET pool index value and the second TAG is associated with the second CORESET pool index value (block 1420). For example, the network node (e.g., using communication manager 150 and/or transmission component 1704, depicted in FIG. 17) may transmit an indication of a first TAG ID and a second TAG ID associated with the serving cell, wherein the first TAG is associated with the first CORESET pool index value and the second TAG is associated with the second CORESET pool index value, as described above.

As further shown in FIG. 14, in some aspects, process 1400 may include transmitting, from the serving cell, an indication of one or more additional PCIs different from the first PCI (block 1430). For example, the network node (e.g., using communication manager 150 and/or transmission component 1704, depicted in FIG. 17) may transmit, from the serving cell, an indication of one or more additional PCIs different from the first PCI, as described above.

As further shown in FIG. 14, in some aspects, process 1400 may include communicating with a UE on the serving cell using a multi-TAG configuration or a single-TAG configuration based at least in part on PCIs associated with the first CORESET pool index value and the second CORESET pool index value (block 1440). For example, the network node (e.g., using communication manager 150, transmission component 1704, and/or reception component 1702, depicted in FIG. 17) may communicate with a UE on the serving cell using a multi-TAG configuration or a single-TAG configuration based at least in part on PCIs associated with the first CORESET pool index value and the second CORESET pool index value, as described above.

Process 1400 may include additional aspects, such as any single aspect or any combination of aspects described below and/or in connection with one or more other processes described elsewhere herein.

In a first aspect, communicating with the UE on the serving cell using the multi-TAG configuration or the single-TAG configuration comprises communicating with the UE on the serving cell using a multi-TAG configuration based at least in part on the first CORESET pool index value being associated with the first PCI and the second CORESET pool index value being associated with a second PCI from one of more additional PCIs.

In a second aspect, alone or in combination with the first aspect, process 1400 includes transmitting a first MAC CE indicating one or more active TCI states associated with the first PCI for the second CORESET pool index value that was associated with the second PCI, and communicating with the UE on the serving cell using a single-TAG configuration in response to receiving the first MAC CE.

In a third aspect, alone or in combination with one or more of the first and second aspects, process 1400 includes transmitting an indication to use the first TAG ID or the second TAG ID for the single-TAG configuration.

In a fourth aspect, alone or in combination with one or more of the first through third aspects, process 1400 includes transmitting an indication of one or more active TCI states associated with a third PCI of the one or more additional PCI for the second CORESET pool index value that was associated with the first PCI, and communicating with the UE using a TA of the second TAG to the second CORESET pool index value based at least in part on the TA being indicated for the second CORESET pool index during a previous multi-TAG configuration and based at least in part on an initial TA for the third PCI not being received.

In a fifth aspect, alone or in combination with one or more of the first through fourth aspects, process 1400 includes transmitting an indication of an initial TA associated with the third PCI for the second TAG, and communicating with the UE applying the initial TA associated with the third PCI for the second TAG associated with the second CORESET pool index.

In a sixth aspect, alone or in combination with one or more of the first through fifth aspects, process 1400 includes transmitting an indication of a configuration for using a multi-TAG configuration or a single TAG configuration based at least in part on the first CORESET pool index and the second CORESET pool index being associated with the first PCI.

In a seventh aspect, alone or in combination with one or more of the first through sixth aspects, communicating with the UE using the multi-TAG configuration or the single-TAG configuration comprises communicating using the multi-TAG configuration based at least in part on switching between using a first PCI for the first CORESET pool index value and a second PCI of the one or more additional PCIs for the second CORESET pool index value and using only the first PCI for both the first CORESET pool index value and the second CORESET pool index value, or switching between using the first PCI for the first CORESET pool index value and the second PCI for the second CORESET pool index value and using the first PCI for the first CORESET pool index value and a third PCI for the second CORESET pool index value.

In an eighth aspect, alone or in combination with one or more of the first through seventh aspects, using the first PCI for both the first CORESET pool index value and the second CORESET pool index value comprises using a first TAG associated with a first CORESET pool index, and using a second TAG associated with a second CORESET pool index.

In a ninth aspect, alone or in combination with one or more of the first through eighth aspects, using the first PCI for the first CORESET pool index value and the second PCI for the second CORESET pool index value comprises using the first TAG associated with the first CORESET pool index for the first PCI, and using the second TAG associated with the second CORESET pool index for the second PCI.

In a tenth aspect, alone or in combination with one or more of the first through ninth aspects, process 1400 includes communicating via the third PCI using a same TAG as used for the second PCI before switching.

In an eleventh aspect, alone or in combination with one or more of the first through tenth aspects, process 1400 includes transmitting an indication of a first TA for the first TAG and a second TA for the second TAG to use for communicating using the multi-TAG configuration.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., network node 110) performs operations associated with TAGs for multiple PCI networks.

As shown in FIG. 15, in some aspects, process 1500 may include transmitting an indication of a set of TAG IDs and associated PCIs of a network on a first serving cell having a first PCI (block 1510). For example, the network node (e.g., using communication manager 150 and/or transmission component 1704, depicted in FIG. 17) may transmit an indication of a set of TAG IDs and associated PCIs of a network on a first serving cell having a first PCI, as described above.

As further shown in FIG. 15, in some aspects, process 1500 may include communicating with a UE using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI (block 1520). For example, the network node (e.g., using communication manager 150, transmission component 1704, and/or reception component 1702, depicted in FIG. 17) may communicate with a UE using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI, as described above.

Process 1500 may include additional aspects, such as any single aspect or any combination of aspects described below and/or in connection with one or more other processes described elsewhere herein.

In a first aspect, the first PCI is associated with a TAG ID and a second PCI of one or more additional PCIs is associated with the TAG ID.

In a second aspect, alone or in combination with the first aspect, process 1500 includes transmitting an indication of a single TA for use in communicating with the network via the first PCI and via the second PCI based at least in part on the first PCI and the second PCI being associated with the TAG ID.

In a third aspect, alone or in combination with one or more of the first and second aspects, process 1500 includes transmitting reference signals associated with the associated PCIs, and receiving an indication of downlink reception timing information associated with the associated PCIs.

In a fourth aspect, alone or in combination with one or more of the first through third aspects, transmitting the indication of the set of TAG IDs and associated PCIs is based at least in part on receiving the indication of the downlink reception timing information associated with the associated PCIs.

In a fifth aspect, alone or in combination with one or more of the first through fourth aspects, process 1500 includes transmitting an indication of associations between the reference signals and the associated PCIs.

In a sixth aspect, alone or in combination with one or more of the first through fifth aspects, receiving the indication of the downlink reception timing information comprises receiving the indication of the downlink reception timing information periodically, semi-persistently, or aperiodically.

In a seventh aspect, alone or in combination with one or more of the first through sixth aspects, the indication of the downlink reception timing information comprises one or more of an indication of a downlink reception timing difference associated with a CORESET pool index value of a third PCI and a second PCI, an indication of a downlink reception timing difference between a first reference signal and a second reference signal, an indication of satisfaction or unsatisfaction of a threshold downlink reception timing difference between a CORESET pool index value of the third PCI and the second PCI or between the first reference signal and the second reference signal, or an indication of a TAG ID of the second PCI that is based at least in part on the downlink reception timing difference between the first reference signal and the second reference signal.

In an eighth aspect, alone or in combination with one or more of the first through seventh aspects, the third PCI is associated with a second serving cell that is a same serving cell as the first serving cell, or the third PCI is associated with the second serving cell that is different from the first serving cell.

In a ninth aspect, alone or in combination with one or more of the first through eighth aspects, a single TAG ID is associated with a first CORESET pool index value of a third PCI and a second PCI of the set of associated PCIs based at least in part on a difference of first timing information associated with the second PCI and second timing information associated with the third PCI satisfying a threshold.

In a tenth aspect, alone or in combination with one or more of the first through ninth aspects, process 1500 includes transmitting an indication of the threshold, wherein the threshold applies to PCIs within a serving cell, or wherein the threshold applies to PCIs of different serving cells.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a network node, or another wireless communication device) using the reception component 1602 and the transmission component 1604. As further shown, the apparatus 1600 may include a communication manager 1608 (e.g., the communication manager 140).

In some aspects, the apparatus 1600 may be configured to perform one or more operations described herein in connection with FIGS. 8-11. Additionally, or alternatively, the apparatus 1600 may be configured to perform one or more processes described herein, such as process 1200 of FIG. 12, process 1300 of FIG. 13, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The reception component 1602 may receive an indication of a first CORESET pool index value and a second CORESET pool index value associated with a serving cell of a network having a first PCI. The reception component 1602 may receive an indication of a first TAG ID and a second TAG ID associated with the serving cell, wherein the first TAG is associated with the first CORESET pool index value and the second TAG is associated with the second CORESET pool index value. The reception component 1602 may receive, from the serving cell, an indication of one or more additional PCIs different from the first PCI. The reception component 1602 and/or the transmission component 1604 may communicate with the network on the serving cell using a multi-TAG configuration or a single-TAG configuration based at least in part on PCIs associated with the first CORESET pool index value and the second CORESET pool index value.

The reception component 1602 may receive a first MAC CE indicating one or more active TCI states associated with the first PCI for the second CORESET pool index value that was associated with the second PCI.

The reception component 1602 and/or the transmission component 1604 may communicate with the network on the serving cell using a single-TAG configuration in response to receiving the first MAC CE.

The communication manager 1608 may select the first TAG ID or the second TAG ID for the single-TAG configuration based at least in part on one or more of a communication protocol or an indication from the network.

The reception component 1602 may receive an indication of one or more active TCI states associated with a third PCI of the one or more additional PCI for the second CORESET pool index value that was associated with the first PCI.

The reception component 1602 and/or the transmission component 1604 may communicate using a TA of the second TAG to the second CORESET pool index value based at least in part on the TA being indicated for the second CORESET pool index during a previous multi-TAG configuration and based at least in part on an initial TA for the third PCI not being received.

The reception component 1602 may receive an indication of the initial TA associated with the third PCI for the second TAG.

The communication manager 1608 may apply the initial TA associated with the third PCI for the second TAG associated with the second CORESET pool index.

The reception component 1602 may receive an indication of a configuration for using a multi-TAG configuration or a single TAG configuration based at least in part on the first CORESET pool index and the second CORESET pool index being associated with the first PCI.

The reception component 1602 and/or the transmission component 1604 may communicate via the third PCI using a same TAG as used for the second PCI before switching.

The reception component 1602 may receive an indication of a first TA for the first TAG and a second TA for the second TAG to use for communicating using the multi-TAG configuration.

The reception component 1602 may receive an indication of a set of TAG IDs and associated PCIs of a network on a first serving cell having a first PCI. The reception component 1602 and/or the transmission component 1604 may communicate with the network using one or more TAGs based at least in part on one or more of at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

The reception component 1602 may receive reference signals associated with the associated PCIs.

The transmission component 1604 may transmit an indication of downlink reception timing information associated with the associated PCIs.

The reception component 1602 may receive an indication of associations between the reference signals and the associated PCIs.

The reception component 1602 may receive an indication of the threshold wherein the threshold applies to PCIs within a serving cell, or wherein the threshold applies to PCIs of different serving cells.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a network node, or another wireless communication device) using the reception component 1702 and the transmission component 1704. As further shown, the apparatus 1700 may include a communication manager 1708 (e.g., communication manager 150).

In some aspects, the apparatus 1700 may be configured to perform one or more operations described herein in connection with FIGS. 8-11. Additionally, or alternatively, the apparatus 1700 may be configured to perform one or more processes described herein, such as process 1400 of FIG. 14, process 1500 of FIG. 15, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver.

The transmission component 1704 may transmit an indication of a first CORESET pool index value and a second CORESET pool index value associated with a serving cell of a network having a first PCI. The transmission component 1704 may transmit an indication of a first TAG ID and a second TAG ID associated with the serving cell, wherein the first TAG is associated with the first CORESET pool index value and the second TAG is associated with the second CORESET pool index value. The transmission component 1704 may transmit, from the serving cell, an indication of one or more additional PCIs different from the first PCI. The reception component 1702 and/or the transmission component 1704 may communicate with a UE on the serving cell using a multi-TAG configuration or a single-TAG configuration based at least in part on PCIs associated with the first CORESET pool index value and the second CORESET pool index value.

The transmission component 1704 may transmit a first MAC CE indicating one or more active TCI states associated with the first PCI for the second CORESET pool index value that was associated with the second PCI.

The reception component 1702 and/or the transmission component 1704 may communicate with the UE on the serving cell using a single-TAG configuration in response to receiving the first MAC CE.

The transmission component 1704 may transmit an indication to use the first TAG ID or the second TAG ID for the single-TAG configuration.

The transmission component 1704 may transmit an indication of one or more active TCI states associated with a third PCI of the one or more additional PCI for the second CORESET pool index value that was associated with the first PCI.

The reception component 1702 and/or the transmission component 1704 may communicate with the UE using a TA of the second TAG to the second CORESET pool index value based at least in part on the TA being indicated for the second CORESET pool index during a previous multi-TAG configuration and based at least in part on an initial TA for the third PCI not being received.

The transmission component 1704 may transmit an indication of an initial TA associated with the third PCI for the second TAG.

The reception component 1702 and/or the transmission component 1704 may communicate with the UE applying the initial TA associated with the third PCI for the second TAG associated with the second CORESET pool index.

The transmission component 1704 may transmit an indication of a configuration for using a multi-TAG configuration or a single TAG configuration based at least in part on the first CORESET pool index and the second CORESET pool index being associated with the first PCI.

The reception component 1702 and/or the transmission component 1704 may communicate via the third PCI using a same TAG as used for the second PCI before switching.

The transmission component 1704 may transmit an indication of a first TA for the first TAG and a second TA for the second TAG to use for communicating using the multi-TAG configuration.

The transmission component 1704 may transmit an indication of a set of TAG IDs and associated PCIs of a network on a first serving cell having a first PCI. The reception component 1702 and/or the transmission component 1704 may communicate with a UE using one or more TAGS based at least in part on one or more of at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

The transmission component 1704 may transmit an indication of a single TA for use in communicating with the network via the first PCI and via the second PCI based at least in part on the first PCI and the second PCI being associated with the TAG ID.

The transmission component 1704 may transmit reference signals associated with the associated PCIs.

The reception component 1702 may receive an indication of downlink reception timing information associated with the associated PCIs.

The transmission component 1704 may transmit an indication of associations between the reference signals and the associated PCIs.

The transmission component 1704 may transmit an indication of the threshold wherein the threshold applies to PCIs within a serving cell, or wherein the threshold applies to PCIs of different serving cells.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving an indication of a first control resource set (CORESET) pool index value and a second CORESET pool index value associated with a serving cell of a network having a first physical cell identifier (PCI); receiving an indication of a first timing advance group (TAG) identifier (ID) and a second TAG ID associated with the serving cell, wherein the first TAG is associated with the first CORESET pool index value and the second TAG is associated with the second CORESET pool index value; receiving, from the serving cell, an indication of one or more additional PCIs different from the first PCI; and communicating with the network on the serving cell using a multi-TAG configuration or a single-TAG configuration based at least in part on PCIs associated with the first CORESET pool index value and the second CORESET pool index value.

Aspect 2: The method of Aspect 1, wherein communicating with the network on the serving cell using the multi-TAG configuration or the single-TAG configuration comprises: communicating with the network on the serving cell using a multi-TAG configuration based at least in part on the first CORESET pool index value being associated with the first PCI and the second CORESET pool index value being associated with a second PCI from one of more additional PCIs.

Aspect 3: The method of Aspect 2, further comprising: receiving a first MAC CE indicating one or more active TCI states associated with the first PCI for the second CORESET pool index value that was associated with the second PCI; and communicating with the network on the serving cell using a single-TAG configuration in response to receiving the first MAC CE.

Aspect 4: The method of Aspect 3, further comprising: selecting the first TAG ID or the second TAG ID for the single-TAG configuration based at least in part on one or more of a communication protocol or an indication from the network.

Aspect 5: The method of any of Aspects 3-4, further comprising: receiving an indication of one or more active TCI states associated with a third PCI of the one or more additional PCI for the second CORESET pool index value that was associated with the first PCI; and communicating using a timing advance (TA) of the second TAG to the second CORESET pool index value based at least in part on the TA being indicated for the second CORESET pool index during a previous multi-TAG configuration and based at least in part on an initial TA for the third PCI not being received.

Aspect 6: The method of Aspect 5, further comprising: receiving an indication of the initial TA associated with the third PCI for the second TAG; and applying the initial TA associated with the third PCI for the second TAG associated with the second CORESET pool index.

Aspect 7: The method of any of Aspects 1-6, further comprising: receiving an indication of a configuration for using a multi-TAG configuration or a single TAG configuration based at least in part on the first CORESET pool index and the second CORESET pool index being associated with the first PCI.

Aspect 8: The method of any of Aspects 1-7, wherein communicating with the network using the multi-TAG configuration or the single-TAG configuration comprises: communicating using the multi-TAG configuration based at least in part on: switching between using a first PCI for the first CORESET pool index value and a second PCI of the one or more additional PCIs for the second CORESET pool index value and using only the first PCI for both the first CORESET pool index value and the second

CORESET pool index value, or switching between using the first PCI for the first CORESET pool index value and the second PCI for the second CORESET pool index value and using the first PCI for the first CORESET pool index value and a third PCI for the second CORESET pool index value.

Aspect 9: The method of Aspect 8, wherein using the first PCI for both the first CORESET pool index value and the second CORESET pool index value comprises: using a first TAG associated with a first CORESET pool index; and using a second TAG associated with a second CORESET pool index.

Aspect 10: The method of Aspect 9, wherein using the first PCI for the first CORESET pool index value and the second PCI for the second CORESET pool index value comprises: using the first TAG associated with the first CORESET pool index for the first PCI; and using the second TAG associated with the second CORESET pool index for the second PCI.

Aspect 11: The method of Aspect 10, switching from using the first PCI for the first CORESET pool index value and the second PCI for the second CORESET pool index value to using the first PCI for the first CORESET pool index value and the third

PCI for the second CORESET pool index value comprises: communicating via the third PCI using a same TAG as used for the second PCI before switching.

Aspect 12: The method of any of Aspects 8-11, further comprising: receiving an indication of a first timing advance (TA) for the first TAG and a second TA for the second TAG to use for communicating using the multi-TAG configuration.

Aspect 13: A method of wireless communication performed by a user equipment (UE), comprising: receiving an indication of a set of timing advance group (TAG) identifier (IDs) and associated physical cell IDs (PCIs) of a network on a first serving cell having a first PCI; and communicating with the network using one or more TAGs based at least in part on one or more of: at least one of the one or more TAGS being associated with one or more additional PCIs, of the associated PCIs, that are each associated with one or more active TCI states, or the one or more TAGs being associated with one or more CORESET pool index values that are each associated with one or more active TCI states associated with the first PCI.

Aspect 14: The method of Aspect 13, wherein the first PCI is associated with a TAG ID and a second PCI of one or more additional PCIs is associated with the TAG ID.

Aspect 15: The method of Aspect 14, wherein, based at least in part on the first PCI and the second PCI being associated with the TAG ID, the UE supports reception of an indication of a single timing advance (TA) for use in communicating with the network via the first PCI and via the second PCI.

Aspect 16: The method of any of Aspects 13-15, further comprising: receiving reference signals associated with the associated PCIs; and transmitting an indication of downlink reception timing information associated with the associated PCIs.

Aspect 17: The method of Aspect 16, wherein receiving the indication of the set of TAG IDs and associated PCIs is based at least in part on transmitting the indication of the downlink reception timing information associated with the associated PCIs.

Aspect 18: The method of any of Aspects 16-17, further comprising: receiving an indication of associations between the reference signals and the associated PCIs.

Aspect 19: The method of any of Aspects 16-18, wherein transmitting the indication of the downlink reception timing information comprises: transmitting the indication of the downlink reception timing information periodically, semi-persistently, or aperiodically.

Aspect 20: The method of any of Aspects 16-19, wherein the indication of the downlink reception timing information comprises one or more of: an indication of a downlink reception timing difference associated with a CORESET pool index value of a third PCI and a second PCI, an indication of a downlink reception timing difference between a first reference signal and a second reference signal, an indication of satisfaction or unsatisfaction of a threshold downlink reception timing difference between a CORESET pool index value of the third PCI and the second PCI or between the first reference signal and the second reference signal, or an indication of a TAG ID of the second PCI that is based at least in part on the downlink reception timing difference between the first reference signal and the second reference signal.

Aspect 21: The method of Aspect 20, wherein the third PCI is associated with a second serving cell that is a same serving cell as the first serving cell, or wherein the third PCI is associated with the second serving cell that is different from the first serving cell.

Aspect 22: The method of any of Aspects 13-21, wherein a single TAG ID is associated with a first CORESET pool index value of a third PCI and a second PCI of the set of associated PCIs based at least in part on a difference of first timing information associated with the second PCI and second timing information associated with the third PCI satisfying a threshold.

Aspect 23: The method of Aspect 22, further comprising: receiving an indication of the threshold, wherein the threshold applies to PCIs within a serving cell, or wherein the threshold applies to PCIs of different serving cells.

Aspect 24: A method of wireless communication performed by a network node, comprising: transmitting an indication of a first control resource set (CORESET) pool index value and a second CORESET pool index value associated with a serving cell of a network having a first PCI; transmitting an indication of a first timing advance group (TAG) identifier (ID) and a second TAG ID associated with the serving cell, wherein the first TAG is associated with the first CORESET pool index value and the second TAG is associated with the second CORESET pool index value; transmitting, from the serving cell, an indication of one or more additional PCIs different from the first PCI; and communicating with a user equipment (UE) on the serving cell using a multi-TAG configuration or a single-TAG configuration based at least in part on physical cell IDs (PCIs) associated with the first CORESET pool index value and the second CORESET pool index value.

Aspect 25: The method of Aspect 24, wherein communicating with the UE on the serving cell using the multi-TAG configuration or the single-TAG configuration comprises: communicating with the UE on the serving cell using a multi-TAG configuration based at least in part on the first CORESET pool index value being associated with the first PCI and the second CORESET pool index value being associated with a second PCI from one of more additional PCIs.

Aspect 26: The method of Aspect 25, further comprising: transmitting a first MAC CE indicating one or more active TCI states associated with the first PCI for the second CORESET pool index value that was associated with the second PCI; and communicating with the UE on the serving cell using a single-TAG configuration in response to receiving the first MAC CE.

Aspect 27: The method of Aspect 26, further comprising: transmitting an indication to use the first TAG ID or the second TAG ID for the single-TAG configuration.

Aspect 28: The method of any of Aspects 26-27, further comprising: transmitting an indication of one or more active TCI states associated with a third PCI of the one or more additional PCI for the second CORESET pool index value that was associated with the first PCI; and communicating with the UE using a timing advance (TA) of the second TAG to the second CORESET pool index value based at least in part on the TA being indicated for the second CORESET pool index during a previous multi-TAG configuration and based at least in part on an initial TA for the third PCI not being received.

Aspect 29: The method of Aspect 28, further comprising: transmitting an indication of an initial TA associated with the third PCI for the second TAG; and communicating with the UE applying the initial TA associated with the third PCI for the second TAG associated with the second CORESET pool index.

Aspect 30: The method of any of Aspects 24-29, further comprising: transmitting an indication of a configuration for using a multi-TAG configuration or a single TAG configuration based at least in part on the first CORESET pool index and the second CORESET pool index being associated with the first PCI.

Aspect 31: The method of any of Aspects 24-30, wherein communicating with the UE using the multi-TAG configuration or the single-TAG configuration comprises: communicating using the multi-TAG configuration based at least in part on: switching between using a first PCI for the first CORESET pool index value and a second PCI of the one or more additional PCIs for the second CORESET pool index value and using only the first PCI for both the first CORESET pool index value and the second CORESET pool index value, or switching between using the first PCI for the first CORESET pool index value and the second PCI for the second CORESET pool index value and using the first PCI for the first CORESET pool index value and a third PCI for the second CORESET pool index value.

Aspect 32: The method of Aspect 31, wherein using the first PCI for both the first CORESET pool index value and the second CORESET pool index value comprises: using a first TAG associated with a first CORESET pool index; and using a second TAG associated with a second CORESET pool index.

Aspect 33: The method of Aspect 32, wherein using the first PCI for the first CORESET pool index value and the second PCI for the second CORESET pool index value comprises: using the first TAG associated with the first CORESET pool index for the first PCI; and using the second TAG associated with the second CORESET pool index for the second PCI.

Aspect 34: The method of Aspect 33, switching from using the first PCI for the first CORESET pool index value and the second PCI for the second CORESET pool index value to using the first PCI for the first CORESET pool index value and the third PCI for the second CORESET pool index value comprises: communicating via the third PCI using a same TAG as used for the second PCI before switching.

Aspect 35: The method of any of Aspects 31-34, further comprising: transmitting an indication of a first timing advance (TA) for the first TAG and a second TA for the second TAG to use for communicating using the multi-TAG configuration.

Aspect 36: A method of wireless communication performed by a network node, comprising: transmitting an indication of a set of timing advance group (TAG) identifier (IDs) and associated physical cell IDs (PCIs) of a network on a first serving cell having a first PCI; and communicating with a user equipment (UE) using one or more TAGs based at least in part on one or more of: at least one of the one or more TAGs being associated with one or more additional PCIs, of the associated PCIs, that are each associated with one or more active TCI states, or the one or more TAGs being associated with one or more CORESET pool index values that are each associated with one or more active TCI states associated with the first PCI.

Aspect 37: The method of Aspect 36, wherein the first PCI is associated with a TAG ID and a second PCI of one or more additional PCIs is associated with the TAG ID.

Aspect 38: The method of Aspect 37, further comprising: transmitting an indication of a single timing advance (TA) for use in communicating with the network via the first PCI and via the second PCI based at least in part on the first PCI and the second PCI being associated with the TAG ID.

Aspect 39: The method of any of Aspects 36-38, further comprising: transmitting reference signals associated with the associated PCIs; and receiving an indication of downlink reception timing information associated with the associated PCIs.

Aspect 40: The method of Aspect 39, wherein transmitting the indication of the set of TAG IDs and associated PCIs is based at least in part on receiving the indication of the downlink reception timing information associated with the associated PCIs.

Aspect 41: The method of any of Aspects 39-40, further comprising: transmitting an indication of associations between the reference signals and the associated PCIs.

Aspect 42: The method of Aspect 39, wherein receiving the indication of the downlink reception timing information comprises: receiving the indication of the downlink reception timing information periodically, semi-persistently, or aperiodically.

Aspect 43: The method of any of Aspects 39-41, wherein the indication of the downlink reception timing information comprises one or more of: an indication of a downlink reception timing difference associated with a CORESET pool index value of a third PCI and a second PCI, an indication of a downlink reception timing difference between a first reference signal and a second reference signal, an indication of satisfaction or unsatisfaction of a threshold downlink reception timing difference between a CORESET pool index value of the third PCI and the second PCI or between the first reference signal and the second reference signal, or an indication of a TAG ID of the second PCI that is based at least in part on the downlink reception timing difference between the first reference signal and the second reference signal.

Aspect 44: The method of Aspect 43, wherein the third PCI is associated with a second serving cell that is a same serving cell as the first serving cell, or wherein the third PCI is associated with the second serving cell that is different from the first serving cell.

Aspect 45: The method of any of Aspects 36-44, wherein a single TAG ID is associated with a first CORESET pool index value of a third PCI and a second PCI of the set of associated PCIs based at least in part on a difference of first timing information associated with the second PCI and second timing information associated with the third PCI satisfying a threshold.

Aspect 46: The method of Aspect 45, further comprising: transmitting an indication of the threshold, wherein the threshold applies to PCIs within a serving cell, or wherein the threshold applies to PCIs of different serving cells.

Aspect 47: An apparatus for wireless communication at a device, comprising a processor; memory coupled with the processor; and instructions stored in the memory and executable by the processor to cause the apparatus to perform the method of one or more of Aspects 1-46.

Aspect 48: A device for wireless communication, comprising a memory and one or more processors coupled to the memory, the one or more processors configured to perform the method of one or more of Aspects 1-46.

Aspect 49: An apparatus for wireless communication, comprising at least one means for performing the method of one or more of Aspects 1-46.

Aspect 50: A non-transitory computer-readable medium storing code for wireless communication, the code comprising instructions executable by a processor to perform the method of one or more of Aspects 1-46.

Aspect 51: A non-transitory computer-readable medium storing a set of instructions for wireless communication, the set of instructions comprising one or more instructions that, when executed by one or more processors of a device, cause the device to perform the method of one or more of Aspects 1-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a first control resource set (CORESET) pool index value and a second CORESET pool index value associated with a serving cell of a network having a first physical cell identifier (PCI);
receive an indication of a first timing advance group (TAG) identifier (ID) and a second TAG ID associated with the serving cell, wherein the first TAG is associated with the first CORESET pool index value and the second TAG is associated with the second CORESET pool index value;
receive, from the serving cell, an indication of one or more additional PCIs different from the first PCI; and
communicate with the network on the serving cell using a multi-TAG configuration or a single-TAG configuration based at least in part on PCIs associated with the first CORESET pool index value and the second CORESET pool index value.

2. The UE of claim 1, wherein the one or more processors, to communicate with the network on the serving cell using the multi-TAG configuration or the single-TAG configuration, are configured to:
communicate with the network on the serving cell using a multi-TAG configuration based at least in part on the first CORESET pool index value being associated with the first PCI and the second CORESET pool index value being associated with a second PCI from one of more additional PCIs.

3. The UE of claim 2, wherein the one or more processors are further configured to:
receive a first MAC CE indicating one or more active TCI states associated with the first PCI for the second CORESET pool index value that was associated with the second PCI; and
communicate with the network on the serving cell using a single-TAG configuration in response to receiving the first MAC CE.

4. The UE of claim 3, wherein the one or more processors are further configured to:
select the first TAG ID or the second TAG ID for the single-TAG configuration based at least in part on one or more of a communication protocol or an indication from the network.

5. The UE of claim 3, wherein the one or more processors are further configured to:
receive an indication of one or more active TCI states associated with a third PCI of the one or more additional PCI for the second CORESET pool index value that was associated with the first PCI; and
communicate using a timing advance (TA) of the second TAG to the second CORESET pool index value based at least in part on the TA being indicated for the second CORESET pool index during a previous multi-TAG configuration and based at least in part on an initial TA for the third PCI not being received.

6. The UE of claim 5, wherein the one or more processors are further configured to:
receive an indication of the initial TA associated with the third PCI for the second TAG; and
apply the initial TA associated with the third PCI for the second TAG associated with the second CORESET pool index.

7. The UE of claim 1, wherein the one or more processors are further configured to:
receive an indication of a configuration for using a multi-TAG configuration or a single TAG configuration based at least in part on the first CORESET pool index and the second CORESET pool index being associated with the first PCI.

8. The UE of claim 1, wherein the one or more processors, to communicate with the network using the multi-TAG configuration or the single-TAG configuration, are configured to:
communicate using the multi-TAG configuration based at least in part on:
switch between using a first PCI for the first CORESET pool index value and a second PCI of the one or more additional PCIs for the second CORESET pool index value and using only the first PCI for both the first CORESET pool index value and the second CORESET pool index value, or
switch between using the first PCI for the first CORESET pool index value and the second PCI for the second CORESET pool index value and using the first PCI for the first CORESET pool index value and a third PCI for the second CORESET pool index value.

9. The UE of claim 8, wherein the one or more processors, to use the first PCI for both the first CORESET pool index value and the second CORESET pool index value, are configured to:
use a first TAG associated with a first CORESET pool index; and
use a second TAG associated with a second CORESET pool index.

10. The UE of claim 9, wherein the one or more processors, to use the first PCI for the first CORESET pool index value and the second PCI for the second CORESET pool index value, are configured to:
use the first TAG associated with the first CORESET pool index for the first PCI; and
use the second TAG associated with the second CORESET pool index for the second PCI.

11. The UE of claim 10, switching from using the first PCI for the first CORESET pool index value and the second PCI for the second CORESET pool index value to using the first PCI for the first CORESET pool index value and the third PCI for the second CORESET pool index value comprises:
communicate via the third PCI using a same TAG as used for the second PCI before switching.

12. The UE of claim 8, wherein the one or more processors are further configured to:
receive an indication of a first timing advance (TA) for the first TAG and a second TA for the second TAG to use for communicating using the multi-TAG configuration.

13. A UE for wireless communication, comprising:
a memory; and
one or more processors, coupled to the memory, configured to:
receive an indication of a set of timing advance group (TAG) identifier (IDs) and associated physical cell IDs (PCIs) of a network on a first serving cell having a first PCI; and
communicate with the network using one or more TAGs based at least in part on one or more of:
at least one of the one or more TAGs being associated with one or more additional PCIs, of the associated PCIs, that are each associated with one or more active TCI states, or
the one or more TAGs being associated with one or more CORESET pool index values that are each associated with one or more active TCI states associated with the first PCI.

14. The UE of claim 13, wherein the first PCI is associated with a TAG ID and a second PCI of one or more additional PCIs is associated with the TAG ID.

15. The UE of claim 14, wherein, based at least in part on the first PCI and the second PCI being associated with the TAG ID, the UE supports reception of an indication of a single timing advance (TA) for use in communicating with the network via the first PCI and via the second PCI.

16. The UE of claim 13, wherein the one or more processors are further configured to:
receive reference signals associated with the associated PCIs; and
transmit an indication of downlink reception timing information associated with the associated PCIs.

17. The UE of claim 16, wherein receiving the indication of the set of TAG IDs and associated PCIs is based at least in part on transmitting the indication of the downlink reception timing information associated with the associated PCIs.

18. The UE of claim 16, wherein the one or more processors are further configured to:
receive an indication of associations between the reference signals and the associated PCIs.

19. The UE of claim 16, wherein the one or more processors, to transmit the indication of the downlink reception timing information, are configured to:
transmit the indication of the downlink reception timing information periodically, semi-persistently, or aperiodically.

20. The UE of claim 16, wherein the indication of the downlink reception timing information comprises one or more of:
an indication of a downlink reception timing difference associated with a CORESET pool index value of a third PCI and a second PCI,
an indication of a downlink reception timing difference between a first reference signal and a second reference signal,
an indication of satisfaction or unsatisfaction of a threshold downlink reception timing difference between a CORESET pool index value of the third PCI and the second PCI or between the first reference signal and the second reference signal, or
an indication of a TAG ID of the second PCI that is based at least in part on the downlink reception timing difference between the first reference signal and the second reference signal.

21. The UE of claim 20, wherein the third PCI is associated with a second serving cell that is a same serving cell as the first serving cell, or
wherein the third PCI is associated with the second serving cell that is different from the first serving cell.

22. The UE of claim 13, wherein a single TAG ID is associated with a first CORESET pool index value of a third PCI and a second PCI of the set of associated PCIs based at least in part on a difference of first timing information associated with the second PCI and second timing information associated with the third PCI satisfying a threshold.

23. The UE of claim 22, wherein the one or more processors are further configured to:
receive an indication of the threshold,
wherein the threshold applies to PCIs within a serving cell, or
wherein the threshold applies to PCIs of different serving cells.

24. A method of wireless communication performed by a user equipment (UE), comprising:
receiving an indication of a first control resource set (CORESET) pool index value and a second CORESET pool index value associated with a serving cell of a network having a first physical cell identifier (PCI);
receiving an indication of a first timing advance group (TAG) identifier (ID) and a second TAG ID associated with the serving cell, wherein the first TAG is associated with the first CORESET pool index value and the second TAG is associated with the second CORESET pool index value;
receiving, from the serving cell, an indication of one or more additional PCIs different from the first PCI; and
communicating with the network on the serving cell using a multi-TAG configuration or a single-TAG configuration based at least in part on PCIs associated with the first CORESET pool index value and the second CORESET pool index value.

25. The method of claim 24, wherein communicating with the network on the serving cell using the multi-TAG configuration or the single-TAG configuration comprises:
communicating with the network on the serving cell using a multi-TAG configuration based at least in part on the first CORESET pool index value being associated with the first PCI and the second CORESET pool index value being associated with a second PCI from one of more additional PCIs.

26. The method of claim 25, further comprising:
receiving a first MAC CE indicating one or more active TCI states associated with the first PCI for the second CORESET pool index value that was associated with the second PCI; and
communicating with the network on the serving cell using a single-TAG configuration in response to receiving the first MAC CE.

27. The method of claim 26, further comprising:
selecting the first TAG ID or the second TAG ID for the single-TAG configuration based at least in part on one or more of a communication protocol or an indication from the network.

28. A method of wireless communication performed by a user equipment (UE), comprising:
receiving an indication of a set of timing advance group (TAG) identifier (IDs) and associated physical cell IDs (PCIs) of a network on a first serving cell having a first PCI; and
communicating with the network using one or more TAGs based at least in part on one or more of:
at least one of the one or more TAGs being associated with one or more additional PCIs, of the associated PCIs, that are each associated with one or more active TCI states, or
the one or more TAGs being associated with one or more CORESET pool index values that are each associated with one or more active TCI states associated with the first PCI.

29. The method of claim 28, wherein the first PCI is associated with a TAG ID and a second PCI of one or more additional PCIs is associated with the TAG ID.

30. The method of claim 28, further comprising:
receiving reference signals associated with the associated PCIs; and
transmitting an indication of downlink reception timing information associated with the associated PCIs.
